(19) United States
(12) Patent Application Publication
(10) Pub. No.: US 2011/0182235 A1
(43) Pub. Date: Jul. 28, 2011

(54) METHOD AND APPARATUS FOR INTER USER-EQUIPMENT TRANSFER (IUT), ACCESS TRANSFER AND FALLBACK INITIATED BY A SERVICE CENTRALIZATION AND CONTINUITY APPLICATION SERVER (SCC AS)

(75) Inventors: Kamel M. Shaheen, King of Prussia, PA (US); Xavier DeFoy, Kirkland (CA)

(73) Assignee: INTERDIGITAL PATENT HOLDINGS, INC., Wilmington, DE (US)

(21) Appl. No.: 12/977,421

(22) Filed: Dec. 23, 2010

Related U.S. Application Data
(60) Provisional application No. 61/289,662, filed on Dec. 23, 2009.
(60) Provisional application No. 61/290,042, filed on Dec. 24, 2009.
(60) Provisional application No. 61/308,193, filed on Feb. 25, 2010.
(60) Provisional application No. 61/308,086, filed on Feb. 25, 2010.

(51) Int. Cl. H04W 8/24

(52) U.S. Cl. 370/328

(57) ABSTRACT

Methods and apparatuses for Inter-User Equipment Transfer (IUT), access transfer (AT) and fallback of an IP Multimedia (IM) Subsystem (IMS) session initiated by a service centralization and continuity application server (SCC AS). The SCC AS receiving information, wherein the information includes availability information, capability information or preference information and processing the information to determine IUT or AT capabilities of one or more IMS-capable wireless transmit/receive units (WTRUs) and initiating AT or IUT.

### CROSS REFERENCE TO RELATED APPLICATIONS

This application claims the benefit of U.S. Provisional Application Ser. No. 61/289,662 filed on Dec. 23, 2009, U.S. Provisional Application Ser. No. 61/290,042 filed on Dec. 24, 2009, U.S. Provisional Application Ser. No. 61/308,193 filed on Feb. 25, 2010 and U.S. Provisional Application Ser. No. 61/308,086 filed on Feb. 25, 2010, the contents of which are hereby incorporated by reference herein.

### BACKGROUND

The Internet Protocol (IP) Multimedia Subsystem (IMS) is an architectural framework for delivering IP-based multimedia services. A wireless transmit/receive unit (WTRU) may connect to an IMS through various access networks, including but not limited to networks based on technology such as Universal Mobile Telecommunication System (UMTS) Terrestrial Radio Access Network (UTRAN), Long Term Evolution (LTE), Worldwide Interoperability for Microwave Access (WiMax), or Wireless Local Area Network (WLAN) technology. One feature available according to the IMS is the transfer of IMS sessions between multiple IMS-capable WTRUs. Accordingly, it would be advantageous for Inter-User Equipment Transfer (IUT), access transfer and fallback of sessions between IMS-capable WTRUs initiated by a service centralization and continuity application server (SCC AS).

### SUMMARY

Methods and apparatuses for Inter-User Equipment Transfer (IUT), access transfer (AT) and fallback of an IP Multimedia (IM) Subsystem (IMS) session initiated by a service centralization and continuity application server (SCC AS). The SCC AS receiving information, wherein the information includes availability information, capability information or preference information and processing the information to determine IUT and/or AT capabilities of one or more IMS-capable wireless transmit/receive units (WTRUs) and initiating IUT and/or AT.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is a diagram of an example of a Internet Protocol (IP) Multimedia Subsystem;

FIG. 3 shows an embodiment of a communication session using third party call control;

FIG. 4 shows an embodiment of a communication session using first party call control;

FIG. 5 shows an embodiment of a communication session using third party call control;

FIG. 6 shows an embodiment of a communication session using first party call control;

FIG. 7 shows a diagram of a communication session including policy and reporting functions;

FIG. 8A1 shows an example of SCC AS initiated IUT based on policy or profile information;

FIG. 8A2 is a continuation of FIG. 8A1;

FIG. 8B1 shows an example of SCC AS initiated access transfer based on policy or profile information;

FIG. 8B2 is a continuation of FIG. 8B1;

FIG. 9A1 shows an example of SCC AS initiated IUT based on location information;

FIG. 9A2 is a continuation of FIG. 9A1;

FIG. 9B1 shows an example of SCC AS initiated access transfer based on location information;

FIG. 9B2 is a continuation of FIG. 9B1;

FIG. 10A1 shows an example of SCC AS initiated load balancing IUT;

FIG. 10A2 is a continuation of FIG. 10A1;

FIG. 10B1 shows an example of SCC AS initiated load balancing access transfer;

FIG. 10B2 is a continuation of FIG. 10B1;

FIG. 11A1 shows an example of SCC AS initiated fallback IUT;

FIG. 11A2 is a continuation of FIG. 11A1;

FIG. 11B1 shows an example of SCC AS initiated fallback access transfer;

FIG. 11B2 is a continuation of FIG. 11B1;

FIG. 11C1 shows an alternative embodiment to FIG. 11A;

FIG. 11C2 is a continuation of FIG. 11C1;

FIG. 11D1 shows an alternative embodiment to FIG. 11B;

FIG. 11D2 is a continuation of FIG. 11D1;

FIG. 12A1 shows an example of SCC AS initiated IUT based on radio coverage;

FIG. 12A2 is a continuation of FIG. 12A1;

FIG. 12B1 shows an example of SCC AS initiated access transfer based on radio coverage; and

FIG. 12B2 is a continuation of FIG. 12B1.

### DETAILED DESCRIPTION

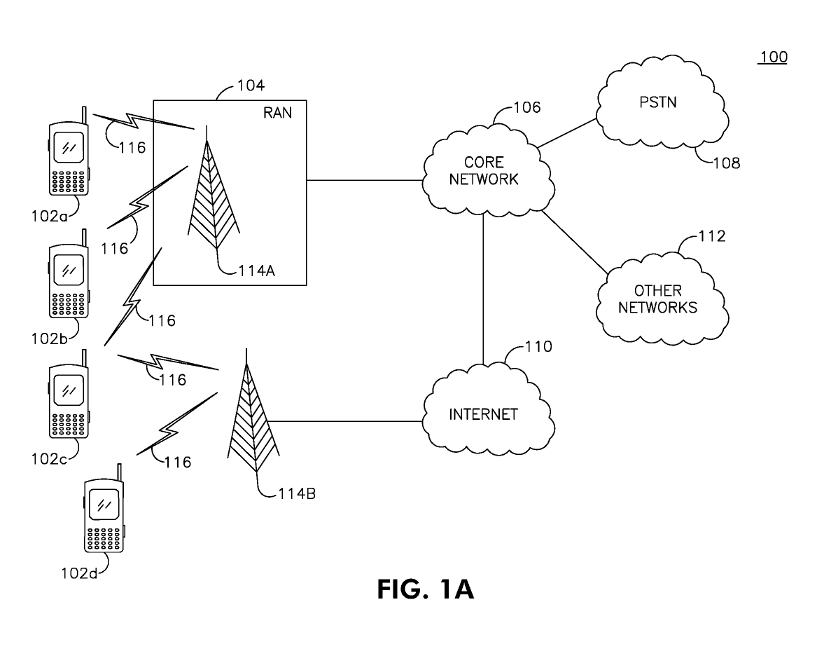

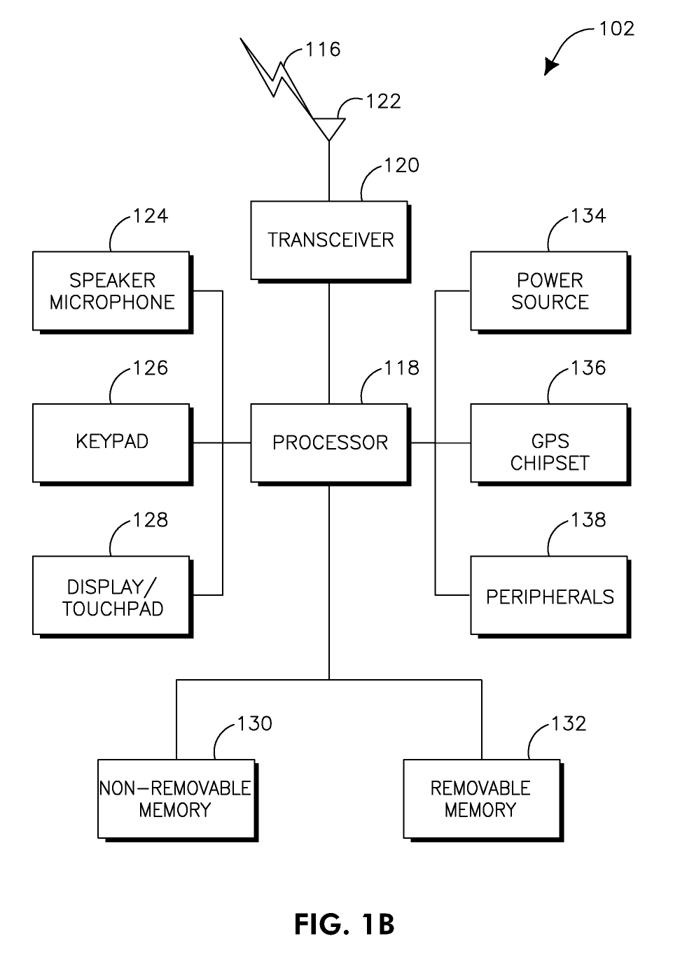

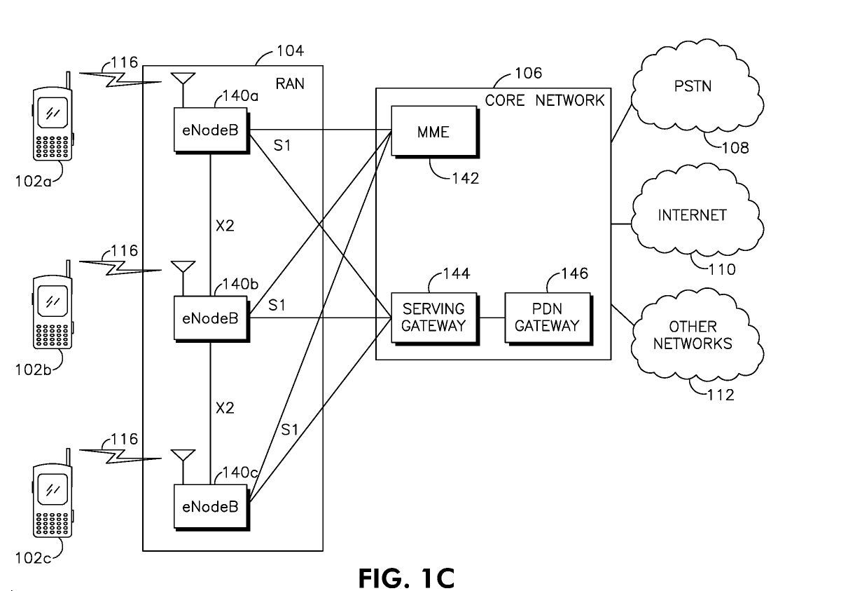

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

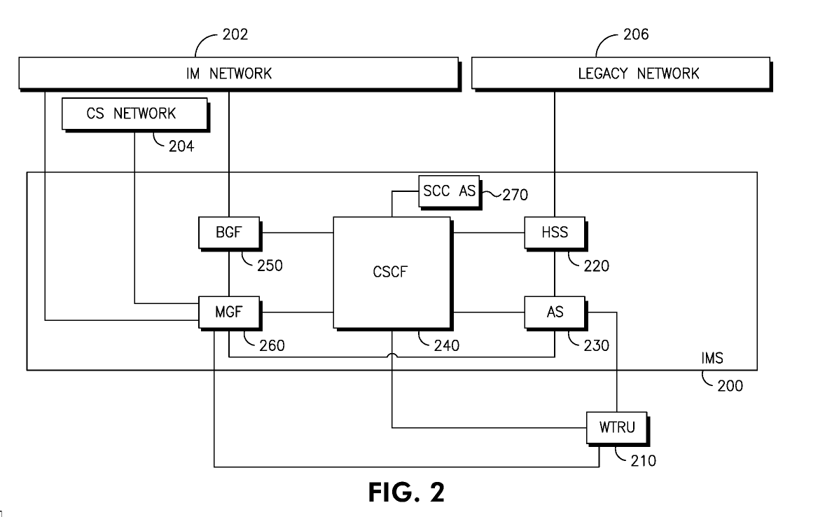

FIG. 2 is a diagram of an example of a Internet Protocol (IP) IP multimedia core network (IM CN), including an IP Multimedia (IM) Subsystem (IMS) 200, an IM network 202, a Circuit Switched (CS) network 204, a legacy network 206, in communication with a wireless transmit/receive unit (WTRU) 210. The IMS 200 includes core network (CN) elements for provision of IM services, such as audio, video, text, chat, or a combination thereof, delivered over the packet switched domain. As shown, the IMS 200 includes a Home Subscriber Server (HSS) 220, an Application Server (AS) 230, a Call Session Control Function (CSCF) 240, a Breakout Gateway Function (BGF) 250, a Media Gateway Function (MGF) 260, and a Service Centralization and Continuity Application Server (SCC AS) 270. In addition to the logical entities and signal paths shown in FIG. 2, an IMS may include any other configuration of logical entities which may be located in one or more physical devices. Although not shown in this logical example, the WTRU may be a separate physical unit and may be connected to the IM CN via a base station such as, a Node-B or an enhanced-NodeB (eNB).

The WTRU 210 may be any type of device configured to operate and/or communicate in a wired and/or wireless environment.

The HSS 220 may maintain and provide subscription-related information to support the network entities handling IM sessions. For example, the HSS may include identification information, security information, location information, and profile information for IMS users.

The AS 230, which may be a SIP Application Server, an OSA Application Server, or a CAMEL IM-SSF, may provide value added IM services and may reside in a home network or in a third party location. The AS may be included in a network, such as a home network, a core network, or a standalone AS network. The AS may provide IM services. For example, the AS may perform the functions of a terminating user agent (UA), a redirect server, an originating UA, a SIP proxy, or a third party call control.

The CSCF 240 may include a Proxy CSCF (P-CSCF), a Serving CSCF (S-CSCF), an Emergency CSCF (E-CSCF), or an Interrogating CSCF (I-CSCF). For example, a P-CSCF may provide a first contact point for the WTRU within the IMS, a S-CSCF may handle session states, and a I-CSCF may provide a contact point within an operator's network for IMS connections destined to a subscriber of that network operator, or to a roaming subscriber currently located within that network operator's service area.

The BGF 250 may include an Interconnection Border Control Function (IBCF), a Breakout Gateway Control Function (BGCF), or a Transition Gateway (TrGW). Although described as a part of the BGF, the IBCF, the BGCF, or the TrGW may each represent a distinct logical entity and may be located in one or more physical entities.

The IBCF may provide application specific functions at the SIP/SDP protocol layer to perform interconnection between operator domains. For example, the IBCF may enable communication between SIP applications, network topology hiding, controlling transport plane functions, screening of SIP signaling information, selecting the appropriate signaling interconnect, and generation of charging data records.

The BGCF may determine routing of IMS messages, such as SIP messages. This determination may be based on information received in the signaling protocol, administrative information, or database access. For example, for PSTN/CS Domain terminations, the BGCF may determine the network in which PSTN/CS Domain breakout is to occur and may select a MGCF.

The TrGW, may be located on the media path, may be controlled by an IBCF, and may provide network address and port translation, and protocol translation.

The MGF 260 may include a Media Gateway Control Function (MGCF), a Multimedia Resource Function Controller (MRFC), a Multimedia Resource Function Processor (MRFP), an IP Multimedia Subsystem—Media Gateway Function (IMS-MGW), or a Media Resource Broker (MRB). Although described as a part of the MGF, the MGCF, the MRFC, the MRFP, the IMS MGW, or the MRB may each represent a distinct logical entity and may be located in one or more physical entities.

The MGCF may control call state connection control for media channels in IMS; may communicate with CSCF, BGCF, and circuit switched network entities; may determine routing for incoming calls from legacy networks; may perform protocol conversion between ISUP/TCAP and the IM subsystem call control protocols; and may forward out of band information received in MGCF to CSCF/IMS-MGW.

The MRFC and MRFP may control media stream resources. The MRFC and MRFP may mix incoming media streams; may source media streams, for example for multimedia announcements; may process media streams, such as by performing audio transcoding, or media analysis; and may provide floor control, such as by managing access rights to shared resources, for example, in a conferencing environment.

The IMS-MGW may terminate bearer channels from a switched circuit network and media streams from a packet network, such as RTP streams in an IP network. The IMS-MGW may support media conversion, bearer control and payload processing, such as, codec, echo canceller, or conference bridge. The IMS-MGW may interact with the MGCF for resource control; manage resources, such an echo canceller; may include a codec. The IMS-MGW may include resources for supporting UMTS/GSM transport media.

The MRB may support the sharing of a pool of heterogeneous MRF resources by multiple heterogeneous applications. The MRB may assign, or releases, specific MRF resources to a call as requested by a consuming application, based on, for example, a specified MRF attribute. For example, when assigning MRF resources to an application, the MRB may evaluate the specific characteristics of the media resources required for the call or calls; the identity of the application; rules for allocating MRF resources across different applications; per-application or per-subscriber SLA or QoS criteria; or capacity models of particular MRF resources.

The SCC AS 270 may provide communication session service continuity, such as duplication, transfer, addition, or deletion of communication sessions, among multiple WTRUs, for example, in a subscription. The SCC AS may perform Access Transfer, Session Transfer or Duplication, Terminating Access Domain Selection (T-ADS), and Handling of multiple media flows. The SCC AS may combine or split media flows over one or more Access Networks. For example, a media flow may be split or combined for Session Transfers, session termination, upon request by the WTRU to add media flows over an additional Access Network during the setup of a session, or upon request by the WTRU to add or delete media flows over one or more Access Networks to an existing sessions.

A communication session may be performed using a communication system, such as the communication system shown in FIG. 1A, between a WTRU, such as the WTRU shown in FIG. 1B, and a remote device. The WTRU may access the communication system via a RAN, such as the RAN shown in FIG. 1C, or any other wired or wireless access network. The communication session may include services, such as IP multimedia (IM) services provided by the IMS as shown in FIG. 2.

The WTRU, the remote device, or the network may control the communication session. Control of the communication session may include, for example, starting or stopping a media flow, adding or removing a media flow, transferring or duplicating a media flow on another WTRU, adjusting a bit-rate, or terminating the communication. For example, a WTRU may initiate a communication session with a remote device. The WTRU may initially control the communication session. The WTRU may pass or share control of the communication session with the remote device.

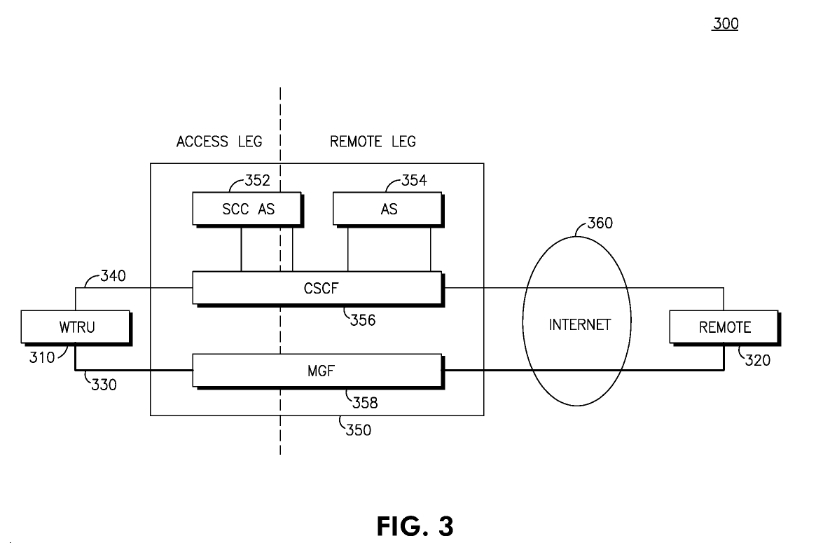

FIG. 3 shows a diagram of an example of a communication session 300 between a WTRU 310 and a remote device 320 using IMS. The communication session 300 may include media flows 330 (media path) and control signaling 340 (control path) between the WTRU 310 and the remote device 320 via a network 350, such as an IM CN as shown in FIG. 2. The IM CN 350 may include an SCC AS 352, an AS 354, a CSCF 356, and a MGF 358.

The communication session 300 may be anchored at the SCC AS 352 associated with the WTRU 310. For example, the SCC AS 352 may maintain information regarding the communication session, such as media flow identifiers and controlling device identifiers, and may provide call control for the communication session 300. For simplicity, the part of the communication session between the WTRU 310 and the SCC AS 352 may be referred to as the access leg, and the part of the communication session between the SCC AS 352 and the remote device 320 may be referred to as the remote leg.

To establish a communication session 300 using IMS the WTRU 310 may initiate a connection (access leg) via the IM CN 350. The WTRU 310 may receive the media flows 330 via the MGF 358 and control signaling 340 via the CSCF 356. The remote device 320 may participate in the communication session 300 via a remote network (remote leg), such as via the Internet 360.

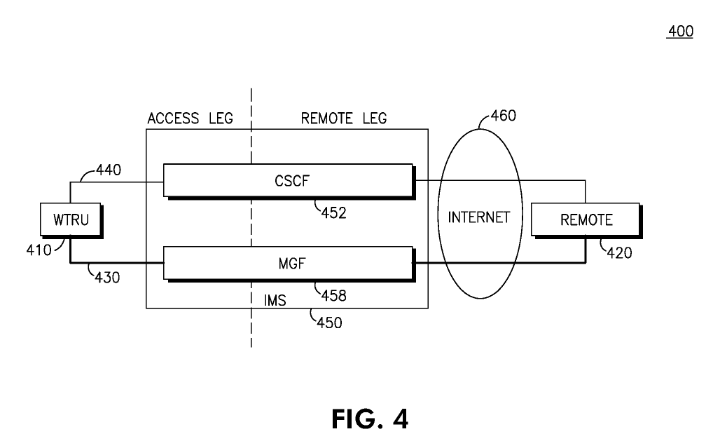

FIG. 4 shows a diagram of an example of a peer-to-peer communication session 400 between a WTRU 410 and a remote unit 420 using IMS. The communication session 400 may include media flows 430 and control signaling 440 established via a network, which may include an IM CN 450, such as the IM CN shown in FIG. 2. The IM CN 450 may include a CSCF 452 and a MGF 458. The WTRU 410 may also receive control signals and media flows directly from the remote device without the use of the IM CN.

To establish a communication session 400 using IMS the WTRU 410 may initiate a connection (access leg) via the IM CN 450. In the access leg, the WTRU 410 may receive the media flows 430 via the MGF 458 and control signaling 440 via the CSCF 452. The WTRU 410, the remote unit 420, or both may maintain the communication and perform call control functions for the communication session 400. The remote device 420 may participate in the communication session 400 via a remote network (remote leg), such as via the Internet 460.

The source WTRU and the target WTRU may be associated via a collaborative session, which may be anchored in a third party, such as the SCC AS.

The source WTRU may initially control the communication session, or may share control with the remote device. The source WTRU may pass control to the target WTRU or may share control with the target WTRU.

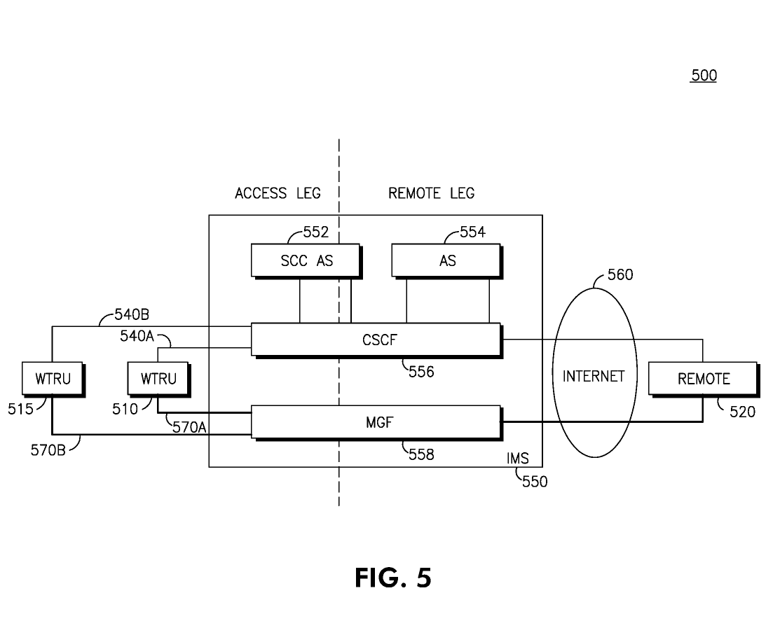

FIG. 5 shows a diagram of an example of a communication session 500. The source WTRU 510 and the target WTRU 515 may participate in the communication session 500 with the remote device 520 via a network 550, such as an IM CN as shown in FIG. 2. The IM CN 550 may include an SCC AS 552, an AS 554, a CSCF 556, and a MGF 558.

The communication session 500 may be anchored at the SCC AS 552 associated with the WTRU 510. For simplicity, the part of the communication session between the WTRUs 510/515 and the SCC AS 552 may be referred to as the access leg, and the part of the communication session between the SCC AS 552 and the remote device 520 may be referred to as the remote leg.

On the access leg, the source WTRU 510 and the target WTRU 515 may receive the duplicated media flows 570A/570B via the MGF 558 and the duplicated control signaling 540A/540B via the SCC AS 552 and the CSCF 556. The remote device 520 may participate in the communication session 500 via a remote network, such as via the Internet 560.

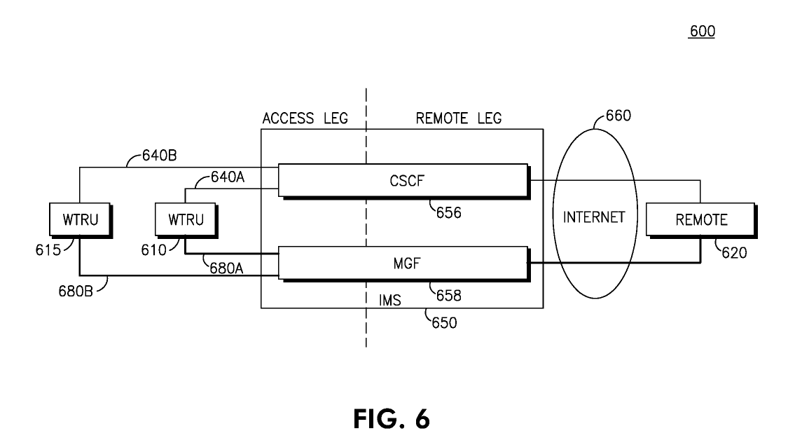

FIG. 6 shows a diagram of an example of a duplicated peer-to-peer communication session 600. The source WTRU 610 and the target WTRU 615 may participate in the duplicated peer-to-peer communication session 600 with the remote device 620 via a network 650, such as an IM CN as shown in FIG. 2. The IM CN 650 may include a CSCF 656, and a MGF 658.

For simplicity, the part of the communication session between the WTRUs 610/615 and the CSCF 656 may be referred to as the access leg, and the part of the communication session between the CSCF 656 and the remote device 620 may be referred to as the remote leg.

On the access leg, the source WTRU 610 and the target WTRU 615 may receive the duplicated media flows 680A/680B via the MGF 658 and the duplicated control signaling 640A/640B via the CSCF 656. The remote device 620 may participate in the communication session 600 via a remote network, such as via the Internet 660. Although FIG. 6 shows the media flow as being duplicated by the MGF 658, the media flows may be duplicated by the remote device 620, for example, using multiple transmitters.

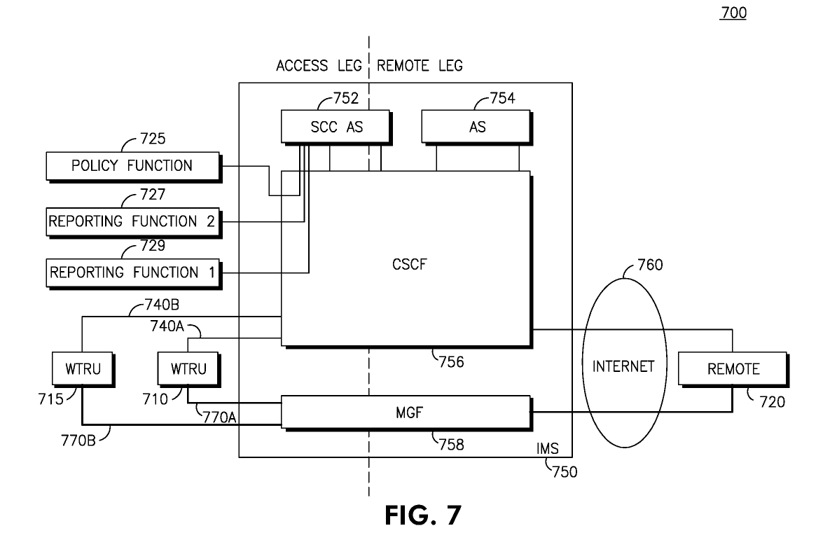

FIG. 7 shows a diagram of a communication session 700 including policy and reporting functions.

The source WTRU 710 and the target WTRU 715 may participate in the communication session 700 with the remote device 720 via a network 750, such as an IM CN as shown in FIG. 2. The IM CN 750 may include an SCC AS 752, an AS 754, a CSCF 756, and a MGF 758.

The communication session 700 may be anchored at the SCC AS 752 associated with WTRU 710. For simplicity, the part of the communication session between WTRUs 710/715 and the SCC AS 752 may be referred to as the access leg, and the part of the communication session between the SCC AS 752 and the remote device 720 may be referred to as the remote leg.

On the access leg, the source WTRU 710 and the target WTRU 715 may receive the duplicated media flows 770A/770B via the MGF 758 and the duplicated control signaling 740A/740B via the SCC AS 752 and the CSCF 756. The remote device 720 may participate in the communication session 700 via a remote network, such as via the Internet 760.

Also on the access leg, the policy function 725, which may be implemented using a Media Independent Handover (MIH) server or it may be an Application Network Discovery and Selection Function (ANDSF), and reporting devices 727/729 may provide policy and reporting information to the SCC AS 752 via the CSCF 756.

Policy information for devices located within the network and for a given network may be accessed via a policy function 725, which may be located in a node, and may be stored along with profile information for each device and the network. The policy function 725 may provide access to policy information via the CSCF 756. Policy information may include but is not limited to whether a WTRU is part of an implicit collaborative session with another WTRU, whether a media flow may be transferred or may not be transferred between WTRUs, which WTRU is preferred for a media flow, type of media that may or may not be transferred or received by another network, and type of media that may or may not be transferred or received by another WTRU.

Reporting information for devices located within the network and for a given network may be accessed via one or more reporting functions 727/729 which may be located in one or more nodes. The reporting function may transmit reporting information to the SCC AS 752 via the CSCF 756. Reporting information may include but is not limited to a network overload event, network location change event, WTRU location change event, loss of access by WTRU indicated by the network, imminent loss of access by WTRU either by the WTRU or by the network, and registration of another WTRU.

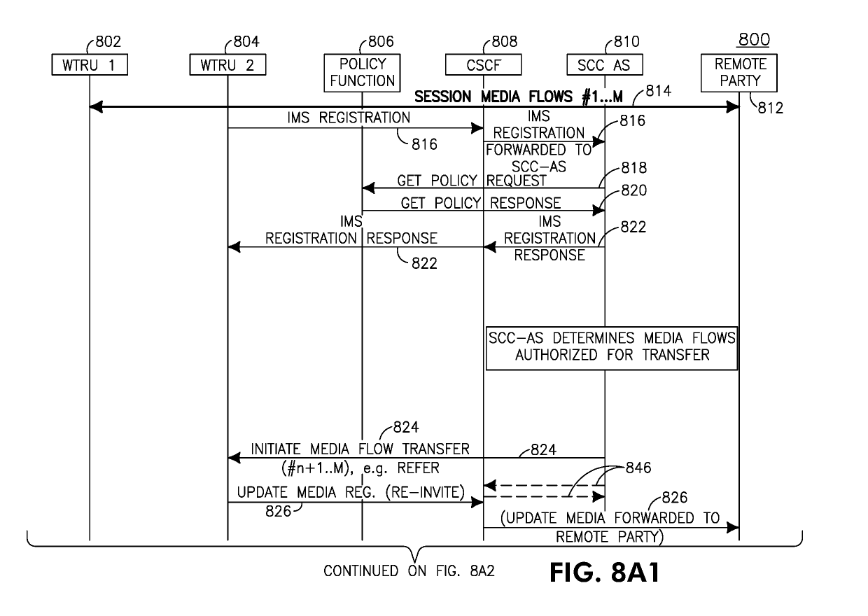

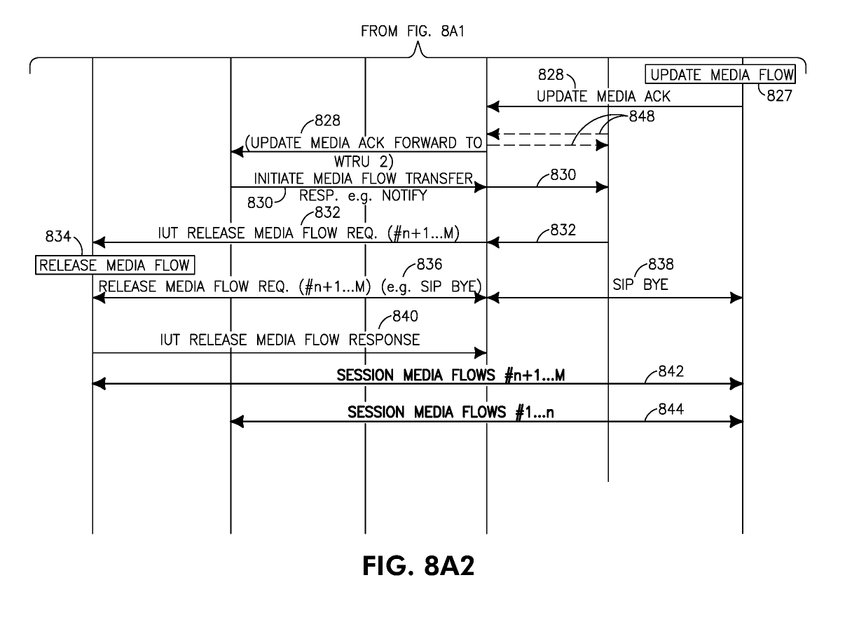

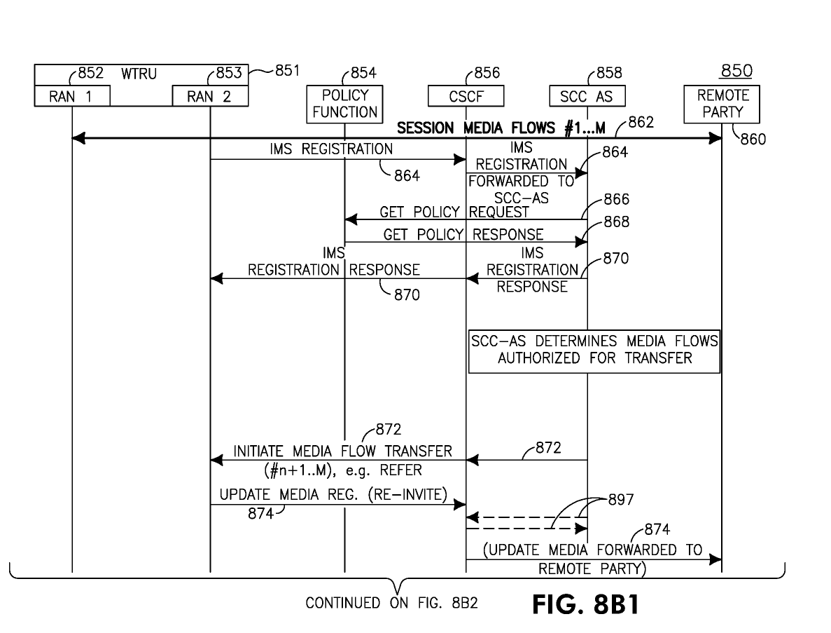

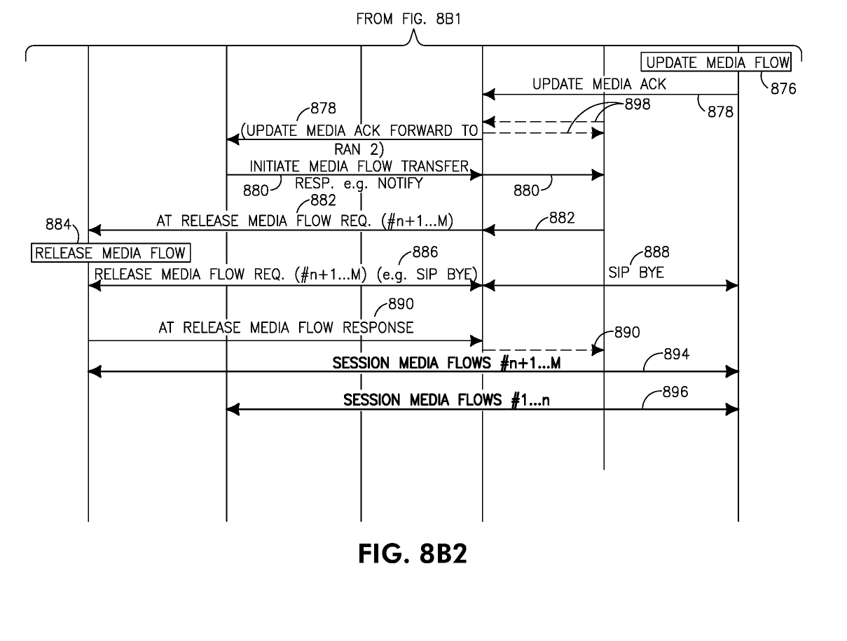

FIGS. 8A1 and 8A2 show an example of SCC AS 810 initiated IUT (e.g., voice/video data) 800 to another WTRU based on policy and/or profile information.

When WTRU1 802 is active in an IMS session, the transfer of session information to WTRU2 804 may provide service continuity. Session transfer procedures initiated by the SCC AS 810 may also be executed, controlled and anchored by the SCC AS 810. In order to execute a session transfer, policy information is provided to the SCC AS 810 by the policy function 806. The SCC AS 810 receives the policy information and initiates transfer from WTRU1 802 to WTRU2 804 based on the received policy information.

The IMS-capable WTRU1 802 communicates using SIP signaling with the Remote Party 812 via the SCC AS 810. The SIP messages may be IMS control plane messages. The IMS-capable WTRU1 802, the SCC AS 810 and the Remote Party 812 may establish one or more media flows (e.g., #1 . . . M) 814. The SCC AS 810 is the anchor for the session and maintains, for all active and inactive sessions, session state information.

Prior to initiating the IUT of a session, the SCC AS 810 may discover that WTRU2 804 is a potential target for a session transfer from WTRU1 802 through the receipt of IMS registration information 816 from WTRU2 804 via CSCF 808. Registration information may include availability information, capability information or preference information.

The SCC AS 810 may request policy information by sending a get policy request 818 to the policy function 806. The get policy request 818 is optional, on a condition that the policy information is already stored at the SCC AS 810. Policy information may also be received periodically, which may be but is not limited to being time based or location based. In addition, registration information may be received periodically, which may be but is not limited to being time based or location based. The registration information may be analyzed in regards to the policy information. In response to the get policy request 818, a get policy response 820 is sent by the policy function 806 to the SCC AS 810.

The SCC AS 810 may decide to transfer IMS session information to WTRU2 804. This determination may be based on one or more preconfigured parameters, profiles, policy information or input from a user. In addition, the SCC AS 810 may determine that WTRU2 804 is part of an implicit collaboration session with WTRU1 802 and whether WTRU2 804 is a preferable candidate for all or some media flows. The media flows authorized for transfer to WTRU2 804 may be determined based on preconfigured parameters or policy information.

The SCC AS sends an IMS registration response 822 to WTRU2 804 via CSCF 808 and an initiates media flow transfer (#n+1 . . . M) 824 to WTRU2 804 via CSCF 808. All media flows determined as non-transferrable to WTRU2 804, based on WTRU2 804 policy information, may not be transferred to WTRU2 804. WTRU2 804 sends an update media flow request (e.g., re-invite) 826 to the CSCF 808. The CSCF 808 sends the update media flow request 826 to the Remote Party 812. The Remote Party 812 updates the media flow 827 and sends an update media flow acknowledgment (ACK) 828 to WTRU2 804 via CSCF 808. WTRU2 804 transmits an initiate media flow transfer response (e.g., notify) 830 to the SCC AS 810 via CSCF 808. The SCC AS 810 sends an IUT release media flow request (#n+1 . . . M) 832, to WTRU1 802 via CSCF 808. WTRU1 802 releases media flow 834 and exchanges release media flow and SIP BYE requests 836 with CSCF 808. WTRU1 802 sends an IUT release media flow response 840 to the CSCF 808. The CSCF 808 exchanges a SIP BYE 838 with the Remote Party 812.

A media flow (#1 . . . n) 844 may be established between WTRU2 804 and the Remote Party 812. WTRU1 802 may exchange media flows (#n+1 . . . M) 842 with the Remote Party 812.

At any point in the method of FIGS. 8A1 and 8A2, additional actions may be performed between WTRU1 802, WTRU2 804, Policy Function 806, CSCF 808, SCC AS 810 and Remote Party 812 according to IMS IUT processes. Upon completion of the embodiment shown in FIGS. 8A1 and 8A2, WTRU1 802 and WTRU2 804 may participate in a collaborative session or the session may have been transferred to WTRU2 804.

In an alternate embodiment of FIGS. 8A1 and 8A2, the SCC AS 810 initiates IUT of session information based on policy and/or profile information. In this embodiment, the SCC AS 810 sends and receives additional IUT signals. After WTRU2 804 sends an update media flow request (e.g., re-invite) 826 to the CSCF 808 and prior to the CSCF 808 sending the update media flow request 826 to the Remote Party 812, the CSCF 808 sends the update media flow request 846 to the SCC AS 810 and the SCC AS 810 sends a response 846. Also, after the Remote Party 812 updates the media flow 827 and sends an update media flow ACK 828 to WTRU2 804 via CSCF 808, and prior to WTRU2 804 transmitting an initiate media flow transfer response 830, the CSCF 808 sends an update media ACK 848 to the SCC AS 810 and the SCC AS 810 sends a response 848.

FIGS. 8B1 and 8B2 show an example of SCC AS 858 initiated access transfer (e.g., voice/video data) 850 to another network based on policy and/or profile information.

When a WTRU 851 is active in an IMS session, the transfer of session information to another network (e.g., a radio access network (RAN)) may provide service continuity. Session transfer procedures initiated by the SCC AS 858 may also be executed, controlled and anchored by the SCC AS 858. In order to execute a session transfer, policy information is provided to the SCC AS 858 by the policy function 854. The SCC AS 858 receives the policy information and initiates transfer from one RAN to another RAN based on the received policy information.

WTRU 851 via RAN1 852 communicates using SIP signaling with the Remote Party 860 via the SCC AS 858. The SIP messages may be IMS control plane messages. WTRU 851 via RAN1 852, the SCC AS 858 and the Remote Party 860 may establish one or more media flows (e.g., #1 . . . M) 862. The SCC AS 858 is the anchor for the session and maintains, for all active and inactive sessions, session state information.

Prior to initiating the access transfer of a session, the SCC AS 858 may discover that RAN2 853 is a potential target for a session transfer from RAN1 852 through the receipt of IMS registration information 864 from RAN2 853 via CSCF 856. The SCC AS 858 may request policy information by sending a get policy request 866 to the policy function 854. The get policy request 866 is optional, on a condition that the policy information is already stored at the SCC AS 858. In response to the get policy request 866, a get policy response 868 is sent by the policy function 854 to the SCC AS 858.

The SCC AS 858 may decide to transfer IMS session information to RAN2 853. This determination may be based on one or more preconfigured parameters, profiles, policy information or input from a user. In addition, the SCC AS 858 may determine that whether RAN2 853 is a preferable candidate for all or some media flows. The media flows authorized for transfer to RAN2 853 may be determined based on preconfigured parameters or policy information.

The SCC AS 858 sends an IMS registration response 870 to RAN2 853 via CSCF 856 and an initiates media flow transfer (#n+1 . . . M) 872 to RAN2 853 via CSCF 856. All media flows determined as non-transferrable to RAN2 853, based on RAN2 853 policy information, may not be transferred to RAN2 853. RAN2 853 sends an update media flow request (e.g., re-invite) 874 to the CSCF 856. The CSCF 856 sends the update media flow request 874 to the Remote Party 860. The Remote Party 860 updates the media flow 876 and sends an update media flow ACK 878 to RAN2 853 via CSCF 856. RAN2 853 transmits an initiate media flow transfer response (e.g., notify) 880 to the SCC AS 858 via CSCF 856. The SCC AS 858 sends an access transfer release media flow request (#n+1 . . . M) 882, to RAN1 852 via CSCF 856. RAN1 852 releases media flow 884 and exchanges release media flow and SIP BYE requests 886 with CSCF 856. RAN1 852 sends an access transfer release media flow response 890 to the SCC AS 858 via the CSCF 856. The CSCF 856 exchanges a SIP BYE 888 with the Remote Party 860.

A media flow (#1 . . . n) 896 may be established between RAN2 853 and the Remote Party 860. RAN1 852 may exchange media flows (#n+1 . . . M) 894 with the Remote Party 860.

At any point in the method of FIGS. 8B1 and 8B2, additional actions may be performed between WTRU 851, RAN1 852, RAN2 853, Policy Function 854, CSCF 856, SCC AS 858 and the Remote Party 860 according to IMS access transfer processes. Upon completion of the embodiment shown in FIGS. 8B1 and 8B2, RAN1 852 and RAN2 853 may participate in a collaborative session or the session may have been transferred to RAN2 853.

In an alternate embodiment of FIGS. 8B1 and 8B2, the SCC AS 858 initiates access transfer of session information based on policy and/or profile information. In this embodiment, the SCC AS 858 sends and receives additional access transfer signals. After the RAN2 853 sends an update media flow request (e.g., re-invite) 874 to the CSCF 856 and prior to the CSCF 856 sending the update media flow request 874 to the Remote Party 860, the CSCF 856 sends the update media flow request 897 to the SCC AS 858 and the SCC AS 858 sends a response 897. Also, after the Remote Party 860 updates the media flow 876 and sends an update media flow ACK 878 to RAN2 853 via CSCF 856, and prior to RAN2 853 transmitting an initiate media flow transfer response 880, the CSCF 856 sends an update media ACK 898 to the SCC AS 858 and the SCC AS 858 sends a response 898.

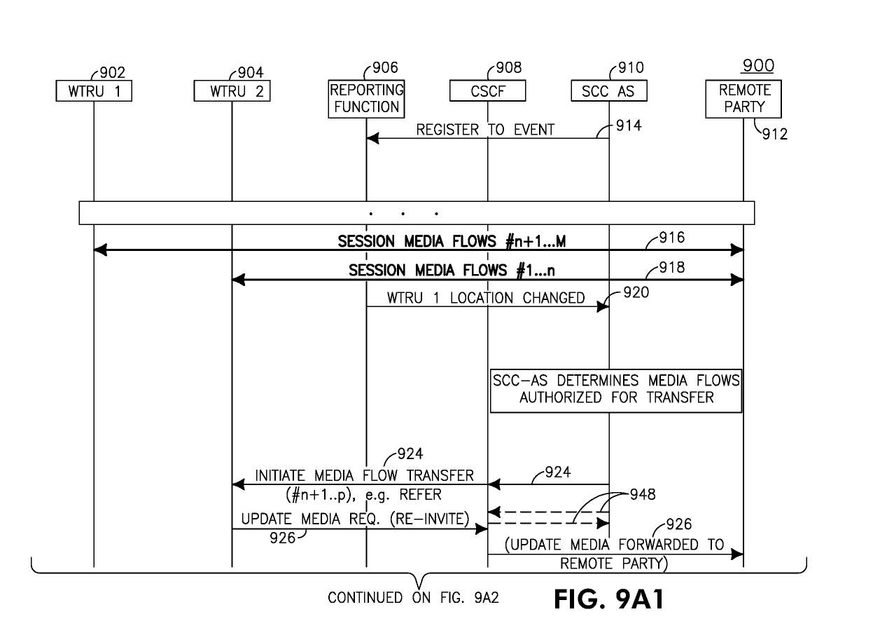

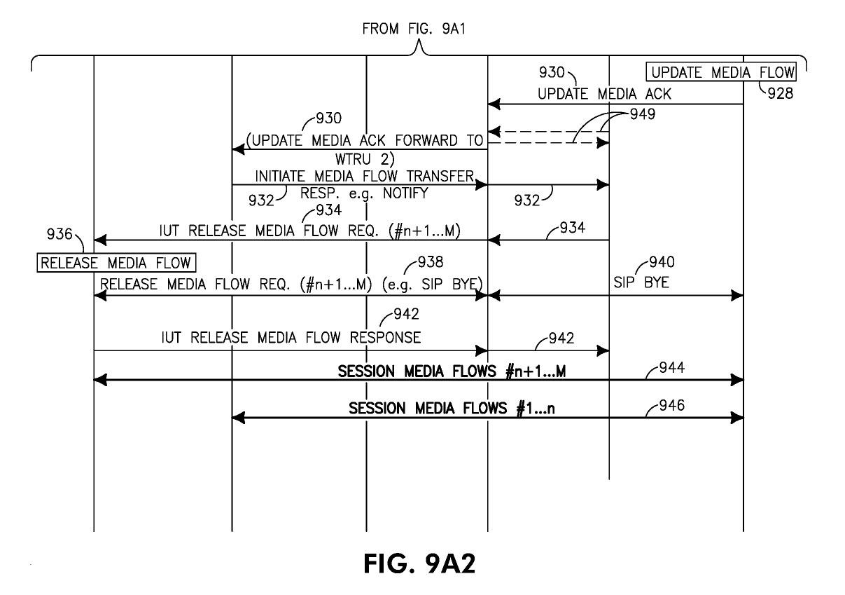

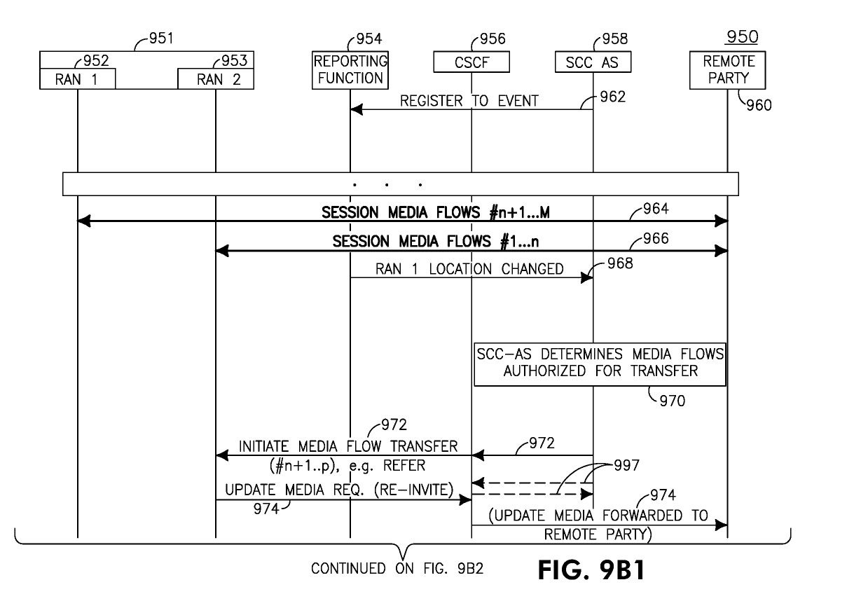

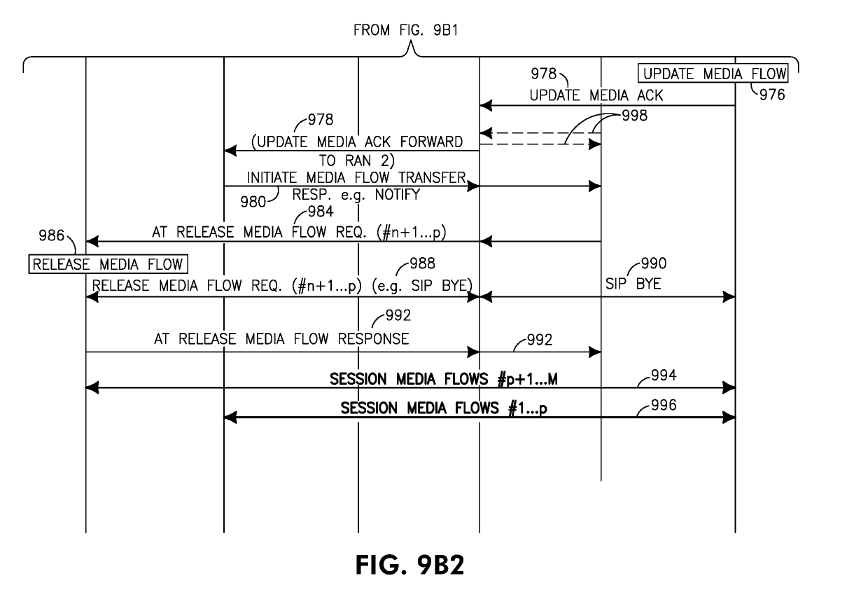

FIGS. 9A1 and 9A2 show an example of SCC AS 910 initiated IUT (e.g., voice/video data) 900 to another WTRU based on reporting information.

When WTRU1 902 is active in an IMS session, the transfer of session information to WTRU2 904 may provide service continuity. Session transfer procedures initiated by the SCC AS 910 may also be executed, controlled and anchored by the SCC AS 910. In order to execute a session transfer, reporting information (e.g., a new location of WTRU) is provided to the SCC AS 910 by the reporting function 906. The SCC AS 910 receives the reporting information and initiates transfer from WTRU1 902 to WTRU2 904 based on the received reporting information.

Prior to session initiation or IUT of a session, the SCC AS 910 may be notified of an event such as a new location for a WTRU. The event may be provided to the SCC AS 910 by a Media Independent Handover (MIH) server, an Application Network Discovery and Selection Function (ANDSF), or via other reporting nodes. The SCC AS may send a request to register 914 the event to the reporting function. Explicit event registration is optional. Registration may occur based on configuration procedures.

The IMS-capable WTRU1 902 communicates using SIP signaling with the Remote Party 912 via the SCC AS 910. The SIP messages may be IMS control plane messages. The IMS-capable WTRU1 902, the SCC AS 910 and the Remote Party 912 may establish one or more media flows (e.g., #n+1 . . . M) 916. In addition, the IMS-capable WTRU2 904, the SCC AS 910 and the Remote Party 912 may establish one or more media flows (e.g., #1 . . . n) 918. The SCC AS 910 is the anchor for the session and maintains, for all active and inactive sessions, session state information.

The SCC AS 910 may receive an indication from the reporting function that an event has occurred 920. For example, WTRU1 902 may have changed its location from location1 to location2. The SCC AS 910 determines 922 that WTRU2 904 is a potential target at location1 for a session transfer of some media flows from WTRU1 902. The SCC AS determines 922 which media flows may be authorized for transfer to WTRU2 904. This determination 922 may be based on one or more preconfigured parameters, profiles, policy information, reporting information or input from a user.

The SCC AS 910 sends an initiates media flow transfer (#n+1 . . . p) 924 to WTRU2 904 via CSCF 908. All media flows determined as non-transferrable to WTRU2 904, which may be based on WTRU2 904 policy information, may not be transferred to WTRU2 904. WTRU2 904 sends an update media flow request (e.g., re-invite) 926 to the CSCF 908. The CSCF 908 sends the update media flow request 926 to the Remote Party 912. The Remote Party 912 updates the media flow 928 and sends an update media flow ACK 930 to WTRU2 904 via CSCF 908. WTRU2 904 transmits an initiate media flow transfer response (e.g., notify) 932 to the SCC AS 910 via CSCF 908. The SCC AS 910 sends an IUT release media flow request (#n+1 . . . M) 934, to WTRU1 902 via CSCF 908. WTRU1 902 releases media flow 936 and exchanges release media flow and SIP BYE requests 938 with CSCF 908. WTRU1 902 sends an IUT release media flow response 942 to the SCC AS 910 via the CSCF 908. The CSCF 908 exchanges a SIP BYE 940 with the Remote Party 912.

A media flow (#1 . . . n) 946 may be established between WTRU2 904 and the Remote Party 912. WTRU1 902 may exchange media flows (#n+1 . . . M) 944 with the Remote Party 912.

At any point in the method of FIGS. 9A1 and 9A2, additional actions may be performed between the WTRU1 902, WTRU2 904, Reporting Function 906, CSCF 908, SCC AS 910 and Remote Party 912 according to IMS IUT processes. Upon completion of the embodiment shown in FIGS. 9A1 and 9A2, WTRU1 902 and WTRU2 904 may participate in a collaborative session or the session may have been transferred to WTRU2 904.

In an alternate embodiment of FIGS. 9A1 and 9A2, the SCC AS 910 initiates IUT of session information based on reporting information. In this embodiment, the SCC AS 910 sends and receives additional IUT signals. After WTRU2 904 sends an update media flow request (e.g., re-invite) 926 to the CSCF 908 and prior to the CSCF 908 sending the update media flow request 926 to the Remote Party 912, the CSCF 908 sends the update media flow request 948 to the SCC AS 910 and the SCC AS 910 sends a response 948. Also, after the Remote Party 912 updates the media flow 928 and sends an update media flow ACK 930 to WTRU2 904 via CSCF 908, and prior to WTRU2 904 transmitting an initiate media flow transfer response 932, the CSCF 908 sends an update media ACK 949 to the SCC AS 910 and the SCC AS 910 sends a response 949.

FIGS. 9B1 and 9B2 show an example of SCC AS 958 initiated access transfer (e.g., voice/video data) 950 to another network based on reporting information.

When WTRU 951 via RAN1 952 is active in an IMS session, the transfer of session information RAN2 953 may provide service continuity. Session transfer procedures initiated by the SCC AS 958 may also be executed, controlled and anchored by the SCC AS 958. In order to execute a session transfer, reporting information (e.g., a new location of RAN1) is provided to the SCC AS 958. The SCC AS 958 receives the reporting information from the reporting function 954 and initiates transfer from RAN1 952 to RAN2 953 based on the received reporting information.

Prior to session initiation or access transfer of a session, the SCC AS 958 may be notified of an event such as a new location for RAN1 952. The SCC AS 958 may send a request to register the event 962 to the reporting function 954. Explicit event registration is optional. Registration may occur based on configuration procedures.

WTRU 951 via RAN1 952 and via RAN2 953 communicates using SIP signaling with the Remote Party 960 via the SCC AS 958. The SIP messages may be IMS control plane messages. WTRU 951 via RAN1 952, the SCC AS 958 and the Remote Party 960 may establish one or more media flows (e.g., #n+1 . . . M) 964. In addition, WTRU 951 via RAN2 953, the SCC AS 958 and the Remote Party 960 may establish one or more media flows (e.g., #1 . . . n) 966. The SCC AS 958 is the anchor for the sessions and maintains, for all active and inactive sessions, session state information.

The SCC AS 958 may receive an indication 968 from the reporting function 954 that an event has occurred. For example, RAN1 952 may have changed its location from locationl to location2. The SCC AS 958 determines 970 that RAN2 953 is a potential target at locationl for a session transfer of some media flows from RAN1 952. The SCC AS 958 determines 970 which media flows may be authorized for transfer to RAN2 953. This determination 970 may be based on one or more preconfigured parameters, profiles, policy information, reporting information or input from a user.

The SCC AS 958 sends an initiates media flow transfer (#n+1 . . . p) 972 to RAN2 953 via CSCF 956. All media flows determined as non-transferrable to RAN2 953, which may be based on RAN2 953 policy information, may not be transferred to RAN2 953. RAN2 953 sends an update media flow request (e.g., re-invite) 974 to the CSCF 956. The CSCF 956 sends the update media flow request 974 to the Remote Party 960. The Remote Party 960 updates the media flow 976 and sends an update media flow ACK 978 to RAN2 953 via CSCF 956. RAN2 953 transmits an initiate media flow transfer response (e.g., notify) 980 to the SCC AS 958 via CSCF 956. The SCC AS 958 sends an access transfer release media flow request (#n+1 . . . p) 984, to RAN1 952 via CSCF 956. RAN1 952 releases media flow 986 and exchanges release media flow and SIP BYE requests 988 with CSCF 956. RAN1 952 sends an access transfer release media flow response 992 to the SCC AS 958 via the CSCF 956. The CSCF 956 exchanges a SIP BYE 990 with the Remote Party 960.

A media flow (#1 . . . p) 996 may be established between RAN2 953 and the Remote Party 960. RAN1 952 may exchange media flows (#p+1 . . . M) 994 with the Remote Party 960.

At any point in the method of FIGS. 9B1 and 9B2, additional actions may be performed between WTRU1 951, RAN1 952, RAN2 953, Reporting Function 954, CSCF 956, SCC AS 958 and Remote Party 960 according to IMS access transfer processes. Upon completion of the embodiment shown in FIGS. 9B1 and 9B2, RAN1 952 and RAN2 953 may participate in a collaborative session or the session may have been transferred to RAN2 953.

In an alternate embodiment of FIGS. 9B1 and 9B2, the SCC AS 958 initiates access transfer of session information based on reporting information. In this embodiment, the SCC AS 958 sends and receives additional access transfer signals. After the RAN2 953 sends an update media flow request (e.g., re-invite) 974 to the CSCF 956 and prior to the CSCF 956 sending the update media flow request 974 to the Remote Party 960, the CSCF 956 sends the update media flow request 997 to the SCC AS 958 and the SCC AS 958 sends a response 997. Also, after the Remote Party 960 updates the media flow 976 and sends an update media flow ACK 978 to RAN2 953 via CSCF 956, and prior to RAN2 953 transmitting an initiate media flow transfer response 980, the CSCF 956 sends an update media ACK 998 to the SCC AS 958 and the SCC AS 958 sends a response 998.

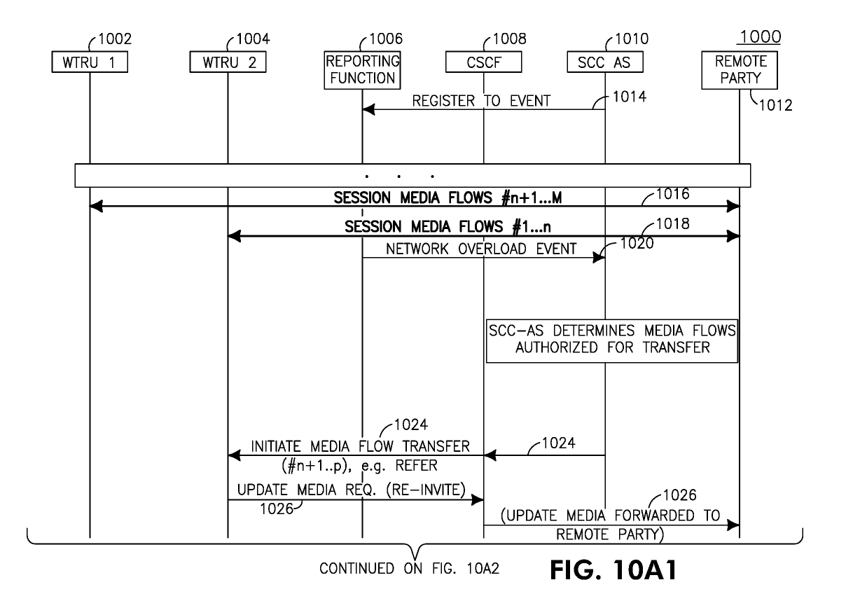

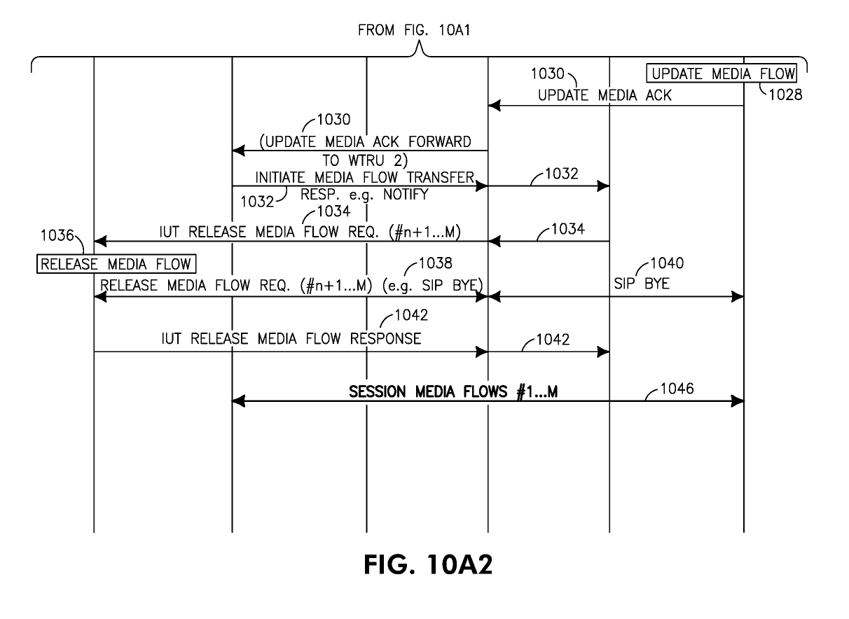

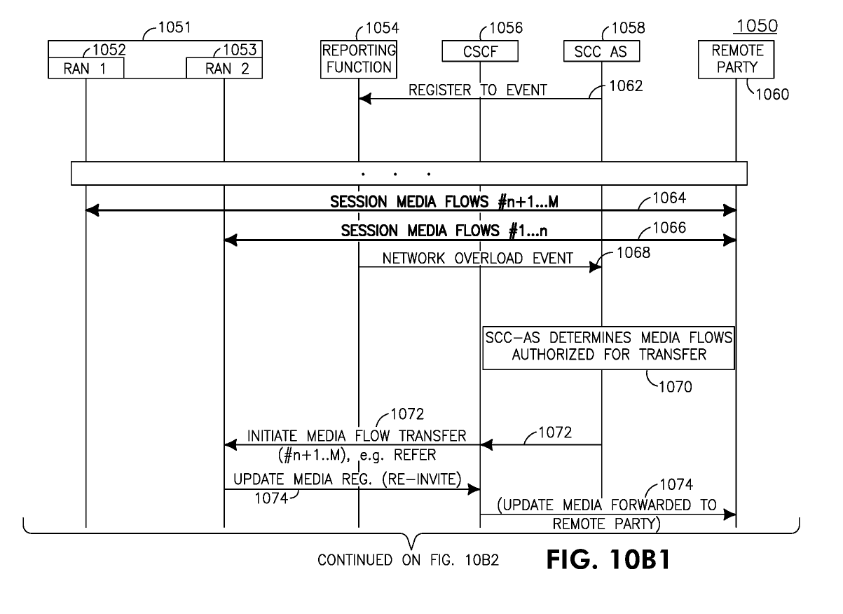

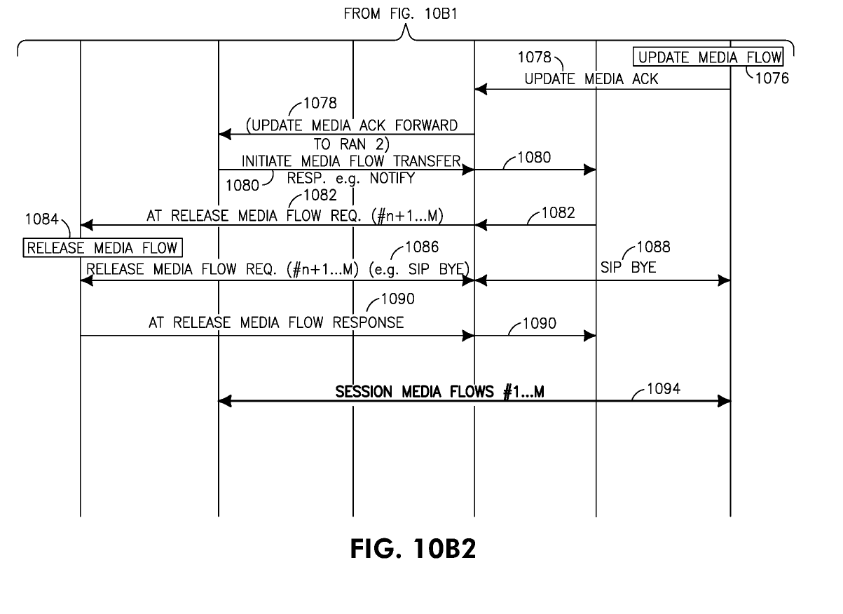

FIGS. 10A1 and 10A2 show an example of SCC AS 1010 initiated load balancing IUT (e.g., voice/video data) 1000 between WTRUs based on reporting information.

When WTRU1 1002 is active in an IMS session, the transfer of session information to WTRU2 1004 may provide service continuity and load balancing. Session transfer procedures initiated by the SCC AS 1010 may also be executed, controlled and anchored by the SCC AS 1010. In order to execute a session transfer, reporting information (e.g., a network overload event) is provided to the SCC AS 1010 by the reporting function 1006. The SCC AS 1010 receives the reporting information and initiates transfer from WTRU1 1002 to WTRU2 1004 based on the received reporting information.

Prior to session initiation or IUT of a session, the SCC AS 1010 may be notified of an event such as a network overload event. The SCC AS 1010 may send a request to register 1014 the event to the reporting function 1006. Explicit event registration is optional. Registration may occur based on configuration procedures.

The IMS-capable WTRU1 1002 communicates using SIP signaling with the Remote Party 1012 via the SCC AS 1010. The SIP messages may be IMS control plane messages. The IMS-capable WTRU1 1002, the SCC AS 1010 and the Remote Party 1012 may establish one or more media flows (e.g., #n+1 . . . M) 1016. In addition, the IMS-capable WTRU2 1004, the SCC AS 1010 and the Remote Party 1012 may establish one or more media flows (e.g., #1 . . . n) 1018. The SCC AS 1010 is the anchor for the session and maintains, for all active and inactive sessions, session state information.

The SCC AS 1010 may receive an indication from the reporting function that an event has occurred 1020. For example, the SCC AS 1010 may receive information regarding a network overload event 1020. The SCC AS 1010 determines that WTRU2 1004 is a potential target and is available for transfer of session information, which may be based on whether WTRU2's 1004 access technology may offload the session information from WTRU1's 1002 congested network. The SCC AS determines 1022 which media flows may be authorized for transfer to WTRU2. This determination 1022 may be based on one or more preconfigured parameters, profiles, policy information, reporting information or input from a user.

The SCC AS 1010 sends an initiate media flow transfer (#n+1 . . . p) request 1024 to WTRU2 1004 via CSCF 1008. All media flows determined as non-transferrable to WTRU2 1004, which may be based on WTRU2 1004 policy information, may not be transferred to WTRU2 1004. WTRU2 1004 sends an update media flow request (e.g., re-invite) 1026 to the CSCF 1008. The CSCF 1008 sends the update media flow request 1026 to the Remote Party 1012. The Remote Party 1012 updates the media flow 1028 and sends an update media flow ACK 1030 to WTRU2 1004 via CSCF 1008. WTRU2 1004 transmits an initiate media flow transfer response (e.g., notify) 1032 to the SCC AS 1010 via CSCF 1008. The SCC AS 1010 sends an IUT release media flow request (#n+1 . . . M) 1034, to WTRU1 1002 via CSCF 1008. WTRU1 1002 releases media flow 1036 and exchanges release media flow and SIP BYE requests 1038 with CSCF 1008. WTRU1 1002 sends an IUT release media flow response 1042 to the SCC AS 1010 via the CSCF 1008. The CSCF 1008 exchanges a SIP BYE 1040 with the Remote Party 1012.

A media flow (#1 . . . M) 1046 may be established between WTRU2 1004 and the Remote Party 1012.

At any point in the method of FIGS. 10A1 and 10A2, additional actions may be performed between WTRU1 1002, WTRU2 1004, Reporting Function 1006, CSCF 1008, SCC AS 1010 and Remote Party 1012 according to IMS IUT processes. Upon completion of the embodiment shown in FIGS. 10A1 and 10A2, WTRU1 1002 and WTRU2 1004 may participate in a collaborative session or the session may have been transferred to WTRU2 1004.

FIGS. 10B1 and 10B2 show an example of SCC AS 1058 initiated load balancing access transfer (e.g., voice/video data) 1050 between networks based on reporting information.

When WTRU 1051 is active in an IMS session, the transfer of session information from RAN1 1052 to RAN2 1053 may provide service continuity and load balancing. Session transfer procedures initiated by the SCC AS 1058 may also be executed, controlled and anchored by the SCC AS 1058. In order to execute a session transfer, reporting information (e.g., a network overload event) is provided to the SCC AS 1058. The SCC AS 1058 receives the reporting information and initiates transfer from RAN1 1052 to RAN2 1053 based on the received reporting information.

Prior to session initiation or access transfer of a session, the SCC AS 1058 may be notified of an event such as a network overload event for RAN1 1052. The SCC AS 1058 may send a request to register the event 1062 to the reporting function 1054. Explicit event registration is optional. Registration may occur based on configuration procedures.

WTRU 1051 via RAN1 1052 and via RAN2 1053 communicate using SIP signaling with the Remote Party 1060 via the SCC AS 1058. The SIP messages may be IMS control plane messages. WTRU 1051 via RAN1 1052, the SCC AS 1058 and the Remote Party 1060 may establish one or more media flows (e.g., #n+1 . . . M) 1064. In addition, WTRU 1051 via RAN2 1053, the SCC AS 1058 and the Remote Party 1060 may establish one or more media flows (e.g., #1 . . . n) 1066. The SCC AS 1058 is the anchor for the sessions and maintains, for all active and inactive sessions, session state information.

The SCC AS 1058 may receive an indication from the reporting function 1054 that an event 1068 has occurred. For example, the SCC AS may receive information regarding a network overload event 1068. The SCC AS 1058 determines that RAN2 1053 is a potential target and is available for transfer of session information, which may be based on whether RAN2′s 1053 access technology may offload the session information from RAN1′s 1052 congested network. The SCC AS 1058 determines 1070 which media flows may be authorized for transfer to RAN2 1053. This determination 1053 may be based on one or more preconfigured parameters, profiles, policy information, reporting information or input from a user.

The SCC AS 1058 sends an initiate media flow transfer (#n+1 . . . M) request 1072 to RAN2 1053 via CSCF 1056. All media flows determined as non-transferrable to RAN2 1053, which may be based on RAN2 1053 policy information, may not be transferred to RAN2 1053. RAN2 1053 sends an update media flow request (e.g., re-invite) 1074 to the CSCF 1056. The CSCF 1056 sends the update media flow request 1074 to the Remote Party 1060. The Remote Party 1060 updates the media flow 1076 and sends an update media flow ACK 1078 to RAN2 1053 via CSCF 1056. RAN2 1053 transmits an initiate media flow transfer response (e.g., notify) 1080 to the SCC AS 1058 via CSCF 1056. The SCC AS 1058 sends an access transfer release media flow request (#n+1 . . . M) 1082, to RAN1 1052 via CSCF 1056. RAN1 1052 releases media flow 1084 and exchanges release media flow and SIP BYE requests 1086 with CSCF 1056. RAN1 1052 sends an access transfer release media flow response 1090 to the SCC AS 1058 via the CSCF 1056. The CSCF exchanges a SIP BYE 1088 with the Remote Party 1060.

A media flow (#1 . . . M) 1094 may be established between RAN2 1053 and the Remote Party 1060.

At any point in the method of FIGS. 10B1 and 10B2, additional actions may be performed between WTRU 1051, RAN1 1052, RAN2 1053, Reporting Function 1054, CSCF 1056, SCC AS 1058 and Remote Party 1060 according to IMS access transfer processes. Upon completion of the embodiment shown in FIGS. 10B1 and 10B2, RAN1 1052 and RAN2 1053 may participate in a collaborative session or the session may have been transferred to RAN2 1053.

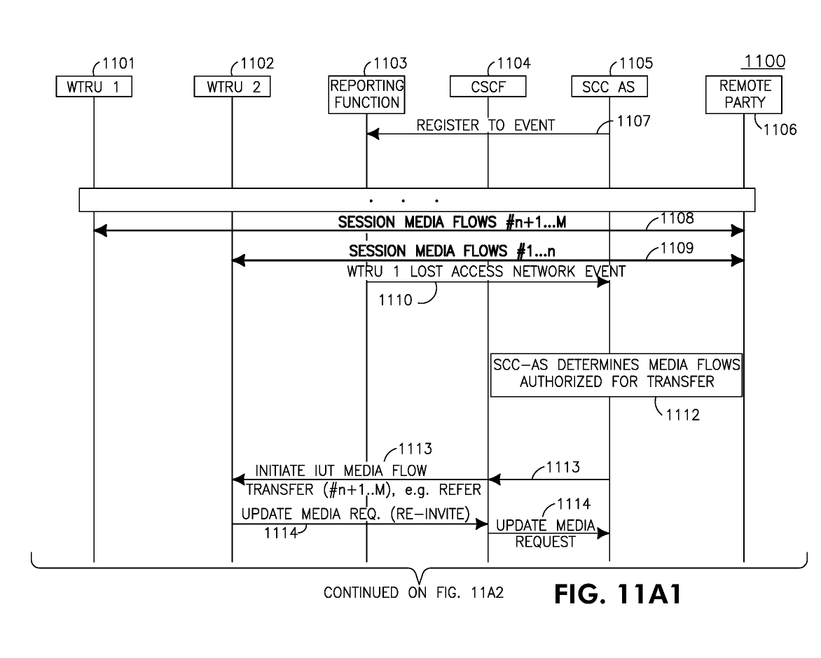

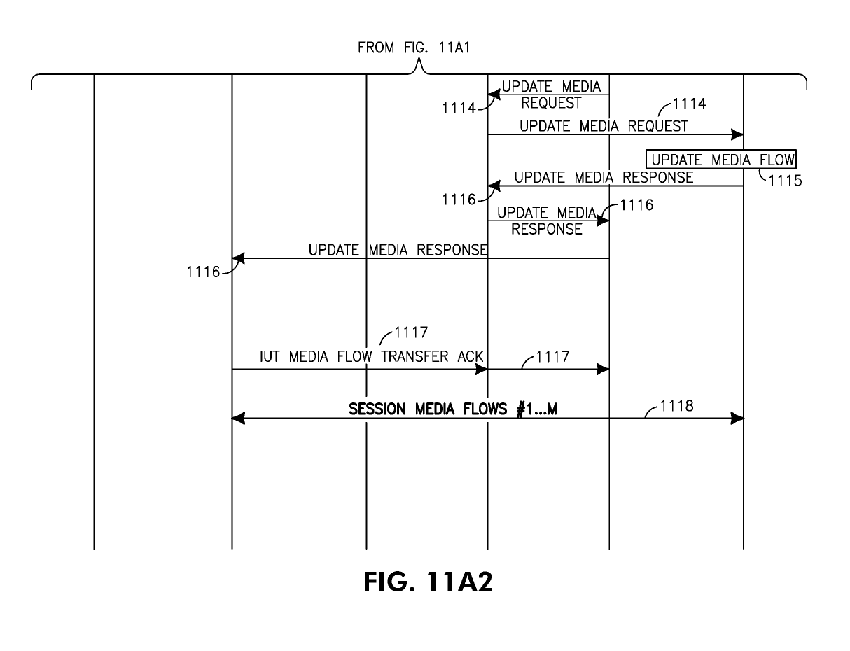

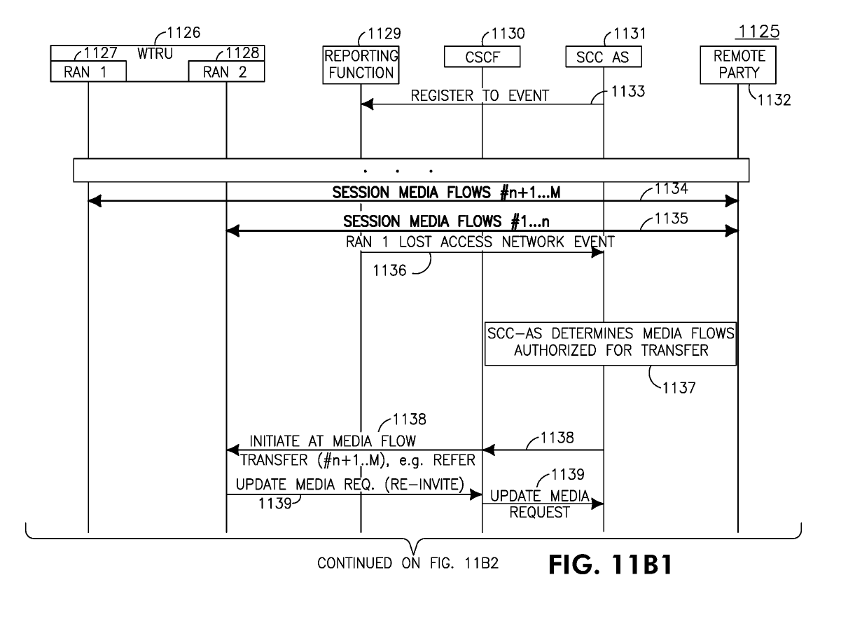

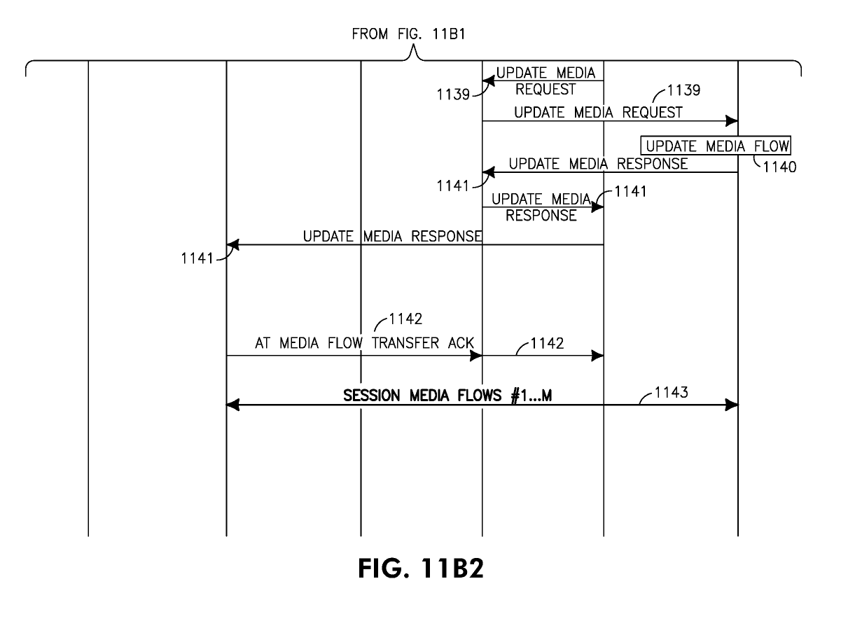

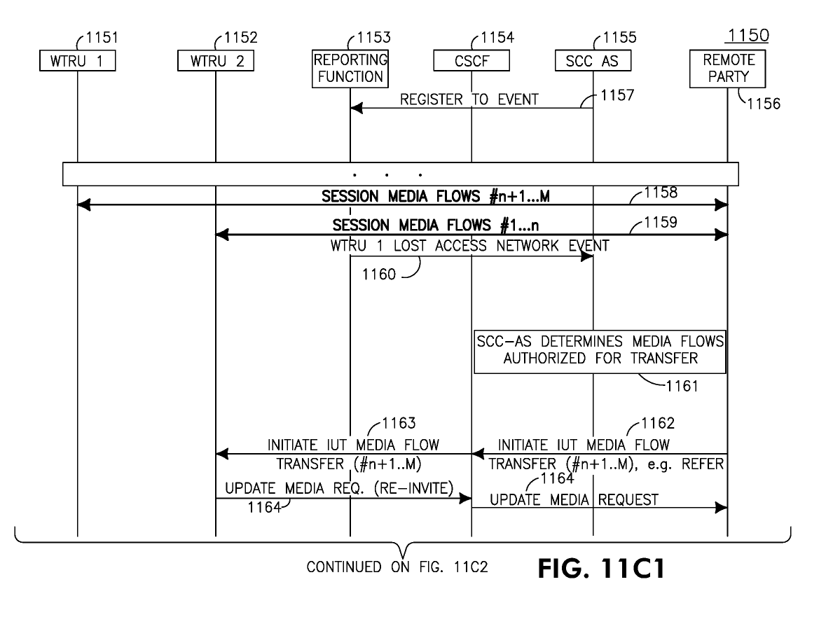

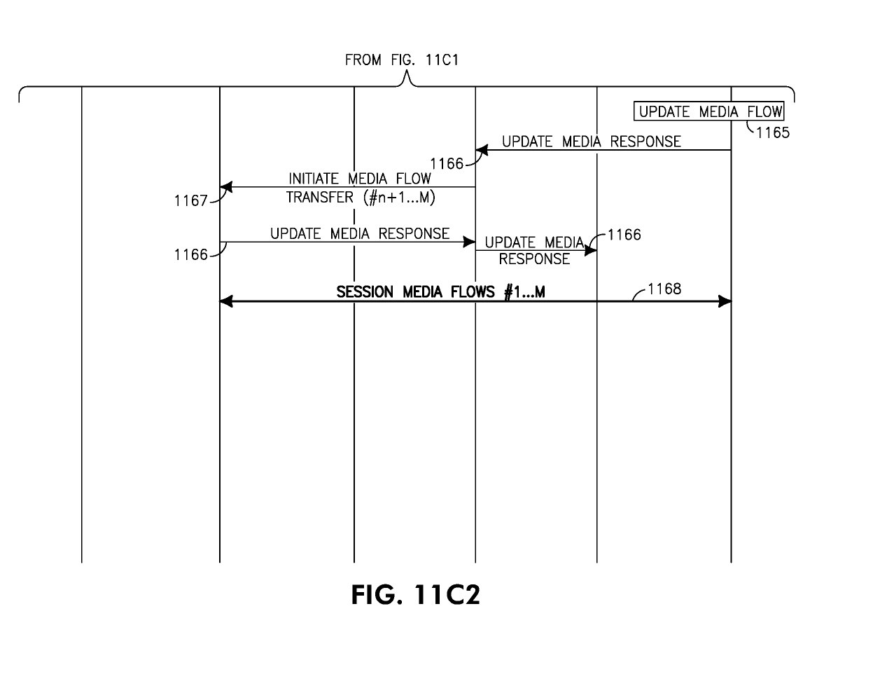

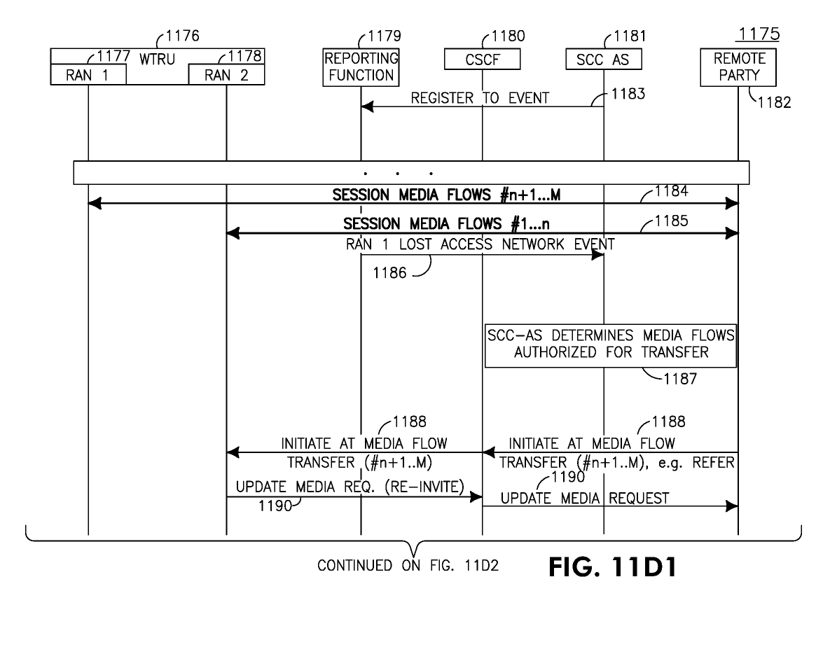

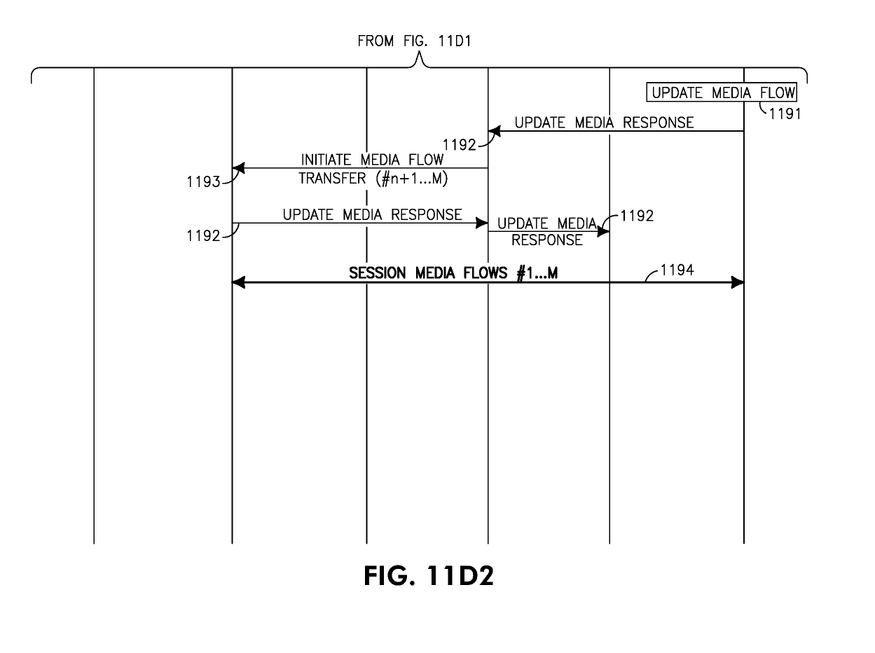

FIGS. 11A1 and 11A2 shows an example of SCC AS 1105 initiated fallback for IUT (e.g., voice/video data) 1100 based on reporting information.

When WTRU1 1101 is active in an IMS session, the transfer of session information to WTRU2 1102 may provide service continuity. In order to execute a session transfer, reporting information (e.g., registration information) is provided to the SCC AS 1105. The SCC AS 1105 receives the reporting information and initiates transfer from WTRU1 1101 to WTRU2 1102. The SCC AS 1105 may also receive reporting information indicting an event, such as a loss of access by WTRU1 1101. The SCC AS 1105 may initiate a fallback (e.g., transfer) of session information to WTRU2 1102 based on the reporting information. Also, an indication may be sent that the transfer is a fallback IUT transfer. Prior to session initiation or IUT of a session, the SCC AS 1105 may be notified of an event such as a loss of access network event. The SCC AS 1105 may send a request to register the event 1107 to the reporting function 1103. Explicit event registration is optional. Registration may occur based on configuration procedures.

The IMS-capable WTRU1 1101 communicates using SIP signaling with the Remote Party 1106 via the SCC AS 1105. The SIP messages may be IMS control plane messages. The IMS-capable WTRU1 1101, the SCC AS 1105 and the Remote Party 1106 may establish one or more media flows (e.g., #n+1 . . . M) 1108. In addition, the IMS-capable WTRU2 1102, the SCC AS 1105 and the Remote Party 1106 may establish one or more media flows (e.g., #1 . . . n) 1109. The SCC AS 1105 is the anchor for the session and maintains, for all active and inactive sessions, session state information.

The SCC AS 1105 may receive an indication 1110 from the reporting function 1103 that an event has occurred. For example, the SCC AS 1105 may receive information regarding a loss of access network event 1110. The SCC AS 1105 determines 1112 that WTRU2 1102 is a potential target and is available for transfer of session information. The SCC AS 1105 determines 1112 which media flows may be authorized for transfer to WTRU2 1102. This determination may be based on one or more preconfigured parameters, profiles, policy information, reporting information or input from a user.

The SCC AS 1105 sends an initiate media flow transfer (#n+1 . . . M) request 1113 to WTRU2 1102 via CSCF 1104. All media flows determined as non-transferrable to WTRU2 1102, which may be based on WTRU2 1102 policy information, may not be transferred to WTRU2 1102. WTRU2 1102 sends an update media flow request (e.g., re-invite) 1114 to SCC AS 1105 via the CSCF 1104. The SCC AS 1105 sends the update media flow request 1114 back to the CSCF 1104 which sends the update media flow request 1114 to the Remote Party 1106. The Remote Party 1106 updates the media flow 1115 and sends an update media flow response 1116 to the CSCF 1104. The CSCF 1104 sends the response 1116 to the SCC AS 1105 and the SCC AS 1105 sends the response 1116 to WTRU2 1102. WTRU2 1102 transmits an IUT media flow ACK 1117 to the SCC AS 1105 via CSCF 1104.

A media flow (#1 . . . M) 1118 may be established between WTRU2 1102 and the Remote Party 1106.

At any point in the method of FIGS. 11A1 and 11A2, additional actions may be performed between WTRU1 1101, WTRU2 1102, Reporting Function 1103, CSCF 1104, SCC AS 1105 and Remote Party 1106 according to IMS IUT processes. Upon completion of the embodiment shown in FIGS. 11A1 and 11A2, WTRU1 1101 and WTRU2 1102 may participate in a collaborative session or the session may have been transferred to WTRU2 1102.

FIGS. 11B1 and 11B2 show an example of SCC AS 1131 initiated fallback for access transfer (e.g., voice/video data) 1125 based on reporting information.

When WTRU 1126 is active in an IMS session, the transfer of session information from RAN1 1127 to RAN2 1128 may provide service continuity. In order to execute a session transfer, reporting information (e.g., registration information) is provided to the SCC AS 1131. The SCC AS 1131 receives the reporting information and initiates transfer from RAN1 1127 to RAN2 1128. The SCC AS may also receive reporting information indicting an event, such as a loss of access by RAN1 1127. The SCC AS 1131 may initiate a fallback (e.g., transfer) of session information to RAN2 1128 based on the reporting information.

Prior to session initiation or access transfer of a session, the SCC AS 1131 may be notified of an event such as a loss of access network event. The SCC AS 1131 may send a request to register the event 1133 to the reporting function 1129. Explicit event registration is optional. Registration may occur based on configuration procedures.

WTRU 1126 via RAN1 1127 communicates using SIP signaling with the Remote Party 1132 via the SCC AS 1131. The SIP messages may be IMS control plane messages. WTRU 1126 via RAN1 1128, the SCC AS 1131 and the Remote Party 1132 may establish one or more media flows (e.g., #n+1 . . . M) 1134. In addition, WTRU 1126 via RAN2 1128, the SCC AS 1131 and the Remote Party 1132 may establish one or more media flows (e.g., #1 . . . n) 1135. The SCC AS 1131 is the anchor for the session and maintains, for all active and inactive sessions, session state information.

The SCC AS 1131 may receive an indication from the reporting function 1129 that an event has occurred. For example, the SCC AS 1131 may receive information regarding a loss of access network event 1136. The SCC AS 1131 determines that RAN2 1128 is a potential target and is available for transfer of session information. The SCC AS 1131 determines 1137 which media flows may be authorized for transfer to RAN2 1128. This determination 1137 may be based on one or more preconfigured parameters, profiles, policy information, reporting information or input from a user.

The SCC AS 1131 sends an initiate media flow transfer (#n+1 . . . M) request 1138 to RAN2 1128 via CSCF 1130. All media flows determined as non-transferrable to RAN2 1128, which may be based on RAN2 1128 policy information, may not be transferred to RAN2 1128. RAN2 11128 sends an update media flow request (e.g., re-invite) 1139 to SCC AS 1131 via the CSCF 1130. The SCC AS 1131 sends the update media flow request 1139 back to the CSCF 1130 which sends the update media flow request 1139 to the Remote Party 1132. The Remote Party 1132 updates the media flow 1140 and sends an update media flow response 1141 to the CSCF 1130. The CSCF 1130 sends the response 1141 to the SCC AS 1131 and the SCC AS 1131 sends the response 1141 to RAN2 1128. RAN2 1128 transmits an access transfer media flow ACK 1142 to the SCC AS 1131 via CSCF 1130.

A media flow (#1 . . . M) 1143 may be established between RAN2 1128 and the Remote Party 1132.

At any point in the method of FIGS. 11B1 and 11B2, additional actions may be performed between WTRU 1126, RAN1 1127, RAN2 1128, Reporting Function 1129, CSCF 1130, SCC AS 1131 and Remote Party 1132 according to IMS access transfer processes. Upon completion of the embodiment shown in FIGS. 11B1 and 11B2, RAN1 1127 and RAN2 1128 may participate in a collaborative session or the session may have been transferred to RAN2 1128.

FIGS. 11C1 and 11C2 show an alternative embodiment 1150 to FIGS. 11A1 and 11A2.

When WTRU1 1151 is active in an IMS session, the transfer of session information to WTRU2 1152 may provide service continuity. In order to execute a session transfer, reporting information (e.g., registration information) is provided to the SCC AS 1155 by the reporting function 1153. The SCC AS 1155 receives the reporting information and initiates transfer from WTRU1 1151 to WTRU2 1152. The SCC AS 1155 may also receive reporting information indicting an event, such as a loss of access by WTRU1 1151. The SCC AS 1155 may initiate a fallback (e.g., transfer) of session information to WTRU2 1152 based on the reporting information.

Prior to session initiation or IUT of a session, the SCC AS 1155 may be notified of an event such as a loss of access network event. The SCC AS 1155 may send a request to register the event 1157 to the reporting function 1153. Explicit event registration is optional. Registration may occur based on configuration procedures.

The IMS-capable WTRU1 1151 communicates using SIP signaling with the Remote Party 1156 via the SCC AS 1155. The SIP messages may be IMS control plane messages. The IMS-capable WTRU1 1151, the SCC AS 1155 and the Remote Party 1156 may establish one or more media flows (e.g., #n+1 . . . M) 1159. In addition, the IMS-capable WTRU2 1152, the SCC AS 1155 and the Remote Party 1156 may establish one or more media flows (e.g., #1 . . . n) 1159. The SCC AS 1155 is the anchor for the session and maintains, for all active and inactive sessions, session state information.

The SCC AS 1155 may receive an indication from the reporting function 1153 that an event has occurred 1160. For example, the SCC AS 1155 may receive information regarding a loss of access network event 1160. The SCC AS 1155 determines 1161 that WTRU2 1152 is a potential target and is available for transfer of session information. The SCC AS 1155 determines 1161 which media flows may be authorized for transfer to WTRU2 1152. This determination 1161 may be based on one or more preconfigured parameters, profiles, policy information, reporting information or input from a user.

The SCC AS 1155 sends an initiate media flow transfer (#n+1 . . . M) request 1162 to WTRU2 1152 via CSCF 1154. All media flows determined as non-transferrable to WTRU2 1152, which may be based on WTRU2 1152 policy information, may not be transferred to WTRU2 1152. WTRU2 1152 sends an update media flow request (e.g., re-invite) 1164 to the Remote Party 1156 via the CSCF 1154. The Remote Party 1156 updates the media flow 1165 and sends an update media flow response 1166 to the CSCF 1154. The CSCF 1154 sends an initiate media flow transfer (#n+1 . . . M) request 1167 to WTRU2 1152. WTRU2 1152 transmits an update media response 1166 to the SCC AS 1155 via CSCF 1154.

A media flow (#1 . . . M) 1168 may be established between WTRU2 1152 and the Remote Party 1156.

At any point in the method of FIGS. 11C1 and 11C2, additional actions may be performed between WTRU1 1151, WTRU2 1152, Reporting Function 1153, CSCF 1154, SCC AS 1155 and Remote Party 1156 according to IMS IUT processes. Upon completion of the embodiment shown in FIGS. 11C1 and 11C2, WTRU1 1151 and WTRU2 1152 may participate in a collaborative session or the session may have been transferred to WTRU2 1152.

FIGS. 11D1 and 11D2 show an alternative embodiment 1175 to FIGS. 11B1 and 11B2. When a WTRU 1176 is active in an IMS session, the transfer of session information from RAN1 1177 to RAN2 1178 may provide service continuity. In order to execute a session transfer, reporting information (e.g., registration information) is provided to the SCC AS 1181 by the reporting function 1179. The SCC AS 1181 receives the reporting information and initiates transfer from RAN1 1177 to RAN2 1178. The SCC AS 1181 may also receive reporting information indicting an event, such as a loss of access by RAN1 1177. The SCC AS 1181 may initiate a fallback (e.g., transfer) of session information to RAN2 1178 based on the reporting information.

Prior to session initiation or access transfer of a session, the SCC AS 1181 may be notified of an event such as a loss of access network event. The SCC AS 1181 may send a request to register the event 1183 to the reporting function 1179. Explicit event registration is optional. Registration may occur based on configuration procedures.

WTRU 1176 via RAN1 1177 communicates using SIP signaling with the Remote Party 1182 via the SCC AS 1181. The SIP messages may be IMS control plane messages. WTRU 1176 via RAN1 1177, the SCC AS 1181 and the Remote Party 1182 may establish one or more media flows (e.g., #n+1 . . . M) 1184. In addition, WTRU 1176 via RAN2 1178, the SCC AS 1181 and the Remote Party 1182 may establish one or more media flows (e.g., #1 . . . n) 1185. The SCC AS 1181 is the anchor for the session and maintains, for all active and inactive sessions, session state information.

The SCC AS 1181 may receive an indication 1186 from the reporting function 1179 that an event has occurred. For example, the SCC AS 1181 may receive information regarding a loss of access network event 1186. The SCC AS 1181 determines that RAN2 1178 is a potential target and is available for transfer of session information. The SCC AS 1181 determines 1187 which media flows may be authorized for transfer to RAN2 1178. This determination 1187 may be based on one or more preconfigured parameters, profiles, policy information, reporting information or input from a user.

The SCC AS 1181 sends an initiate media flow transfer (#n+1 . . . M) request 1188 to RAN2 1178 via CSCF 1180. All media flows determined as non-transferrable to RAN2 1178, which may be based on RAN2 1178 policy information, may not be transferred to RAN2 1178. RAN2 1178 sends an update media flow request (e.g., re-invite) 1190 to the Remote Party 1182 via the CSCF 1180. The Remote Party 1182 updates the media flow 1191 and sends an update media flow response 1192 to the CSCF 1180. The CSCF 1180 sends an initiate media flow transfer (#n+1 . . . M) 1193 to RAN2 1178. RAN2 1178 transmits an update media response 1192 to the SCC AS 1181 via CSCF 1180.

A media flow (#1 . . . M) 1194 may be established between RAN2 1178 and the Remote Party 1182.

At any point in the method of FIGS. 11D1 and 11D2, additional actions may be performed between WTRU 1176, RAN1 1177, RAN2 1178, Reporting Function 1179, CSCF 1180, SCC AS 1181 and Remote Party 1182 according to IMS access transfer processes. Upon completion of the embodiment shown in FIGS. 11D1 and 11D2, RAN1 1177 and RAN2 1178 may participate in a collaborative session or the session may have been transferred to RAN2 1177.

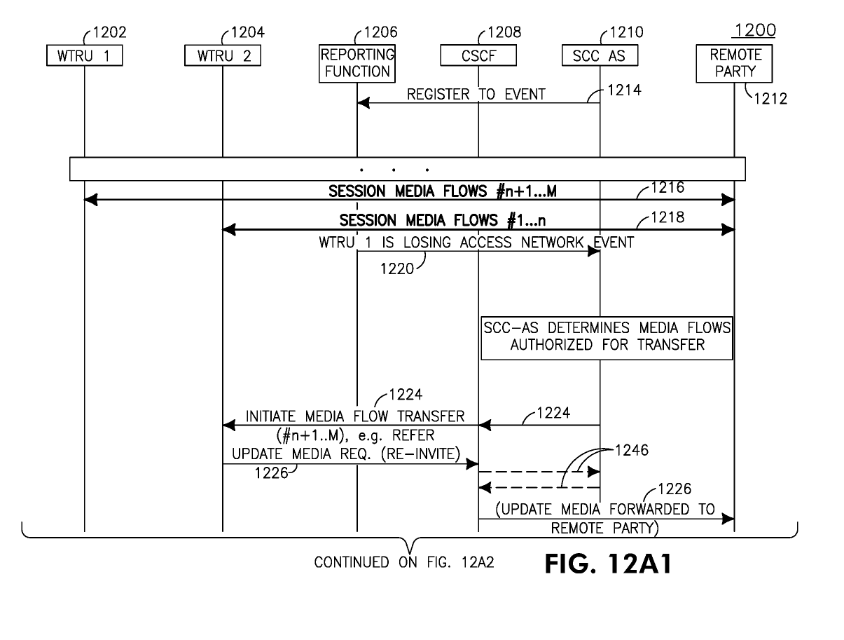

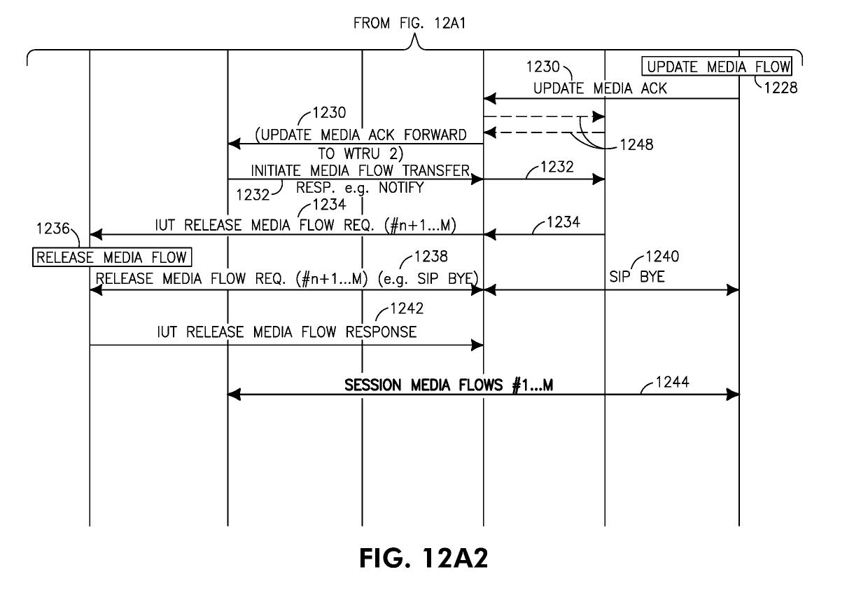

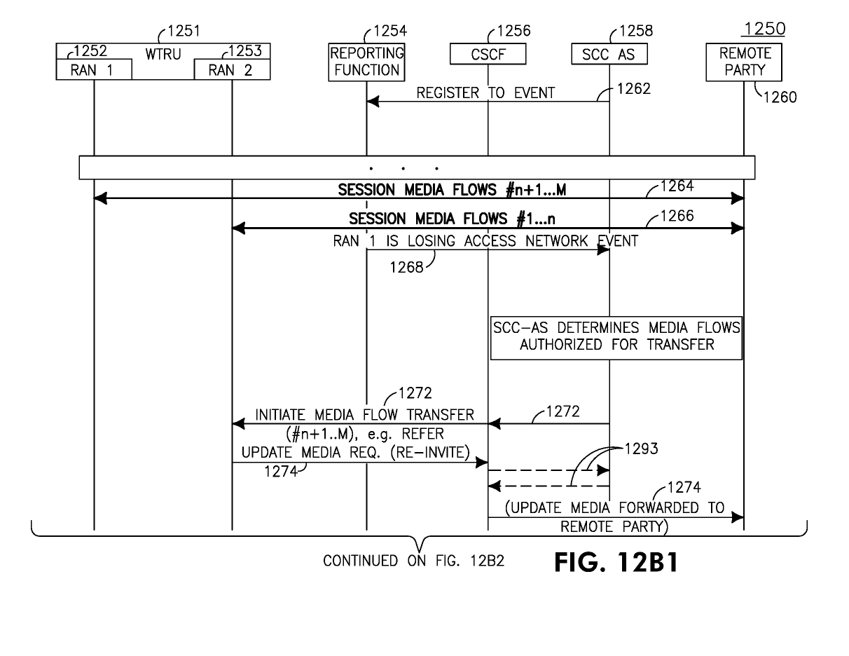

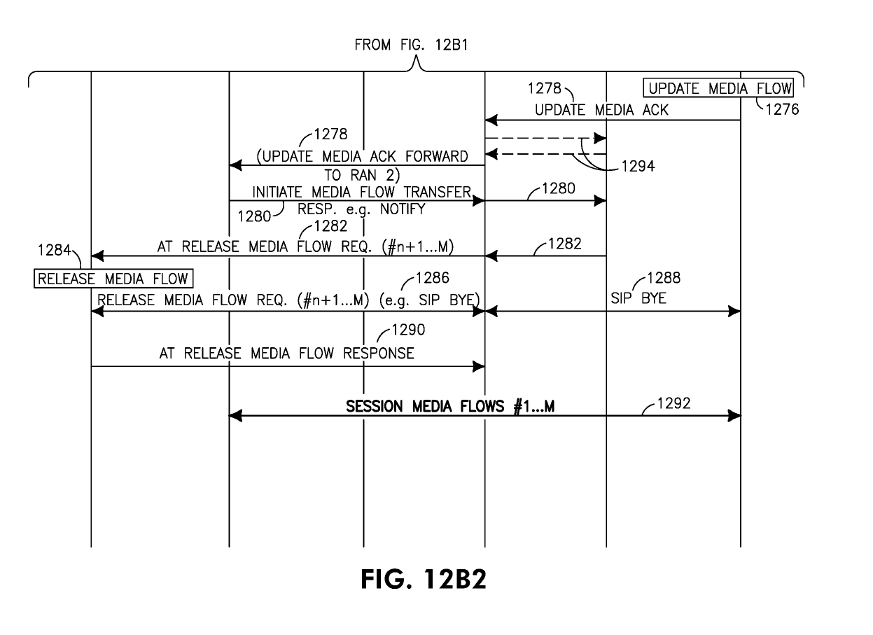

FIGS. 12A1 and 12A2 show an example of SCC AS 1210 initiated IUT of session information (e.g., voice/video data) 1200 based on reporting information regarding a radio coverage event.

When WTRU1 1202 is active in an IMS session, the transfer of session information to WTRU2 1204 may provide service continuity. In order to execute a session transfer, reporting information which may be based on a radio coverage event is provided to the SCC AS 1210 by the reporting function 1206. The SCC AS 1210 receives the reporting information and initiates transfer from WTRU1 1202 to WTRU2 1204 based on the received reporting information.

Prior to session initiation or IUT of a session, the SCC AS 1210 may be notified of an event such as the imminent loss of a current access network by WTRU1 1202. The SCC AS 1210 may send a request to register the event 1214 to the reporting function 1206. Explicit event registration is optional. Registration may occur based on configuration procedures.

The IMS-capable WTRU1 1202 communicates using SIP signaling with the Remote Party 1212 via the SCC AS 1210. The SIP messages may be IMS control plane messages. The IMS-capable WTRU1 1202, the SCC AS 1210 and the Remote Party 1212 may establish one or more media flows (e.g., #n+1 . . . M) 1216. In addition, the IMS-capable WTRU2 1204, the SCC AS 1210 and the Remote Party 1212 may establish one or more media flows (e.g., #1 . . . n) 1218. The SCC AS 1210 is the anchor for the session and maintains, for all active and inactive sessions, session state information.

The SCC AS 1210 may receive an indication 1220 from the reporting function 1206 that an event is about to occur. For example, the SCC AS 1210 may receive information 12220 regarding the imminent loss of a current access network by WTRU1 1202. The SCC AS 1210 determines that WTRU2 1204 is a potential target and is available for transfer of session information. The SCC AS 1210 determines 1222 which media flows may be authorized for transfer to WTRU2 1204. This determination 1222 may be based on one or more preconfigured parameters, profiles, policy information, reporting information or input from a user.

The SCC AS 1210 sends an initiate media flow transfer (#n+1 . . . M) request 1224 to WTRU2 1204 via CSCF 1208. All media flows determined as non-transferrable to WTRU2 1204, which may be based on WTRU2 1204 policy information, may not be transferred to WTRU2 1204. WTRU2 1204 sends an update media flow request (e.g., re-invite) 1226 to the CSCF 1208. The CSCF 1208 sends the update media flow request 1226 to the Remote Party 1212. The Remote Party 1212 updates the media flow 1228 and sends an update media flow ACK 1230 to WTRU2 1204 via the CSCF 1208. WTRU2 1204 transmits an initiate media flow transfer response (e.g., notify) 1232 to the SCC AS 1210 via CSCF 1208. The SCC AS 1210 sends an IUT release media flow request (#n+1 . . . M) 1234, to WTRU1 1202 via CSCF 1208. WTRU1 1202 releases media flow 1236 and exchanges release media flow and SIP BYE requests 1238 with CSCF 1208. WTRU1 1202 sends an IUT release media flow response 1242 to the CSCF 1208. The CSCF 1208 exchanges a SIP BYE 1240 with the Remote Party 1212.

A media flow (#1 . . . M) 1244 may be established between WTRU2 1204 and the Remote Party 1212.

At any point in the method of FIGS. 12A1 and 12A2, additional actions may be performed between WTRU1 1202, WTRU2 1204, Reporting Function 1206, CSCF 1208, SCC AS 1210 and Remote Party 1212 according to IMS IUT processes. Upon completion of the embodiment shown in FIGS. 12A1 and 12A2, WTRU1 1202 and WTRU2 1204 may participate in a collaborative session or the session may have been transferred to WTRU2 1204.

In an alternate embodiment of FIGS. 12A1 and 12A2, the SCC AS 1210 initiates IUT of session information based on a radio coverage event. In this embodiment, the SCC AS 1210 sends and receives additional IUT signals. After WTRU2 1204 sends an update media flow request (e.g., re-invite) 1226 to the CSCF 1208 and prior to the CSCF 1208 sending the update media flow request 1226 to the Remote Party 1212, the CSCF 1208 sends the update media flow request 1246 to the SCC AS 1210 and the SCC AS 1210 sends a response 1246 to the CSCF. Also, after the Remote Party 1212 updates the media flow 1228 and sends an update media flow ACK 1230 to WTRU2 1204 via CSCF 1208, and prior to WTRU2 1204 transmitting an initiate media flow transfer response 1232, the CSCF 1208 sends an update media ACK 1248 to the SCC AS 1210 and the SCC AS 1210 sends a response 1248 to the CSCF 1208.

FIGS. 12B1 and 12B2 shows an example of SCC AS 1258 initiated access transfer of session information (e.g., voice/video data) 1250 based on reporting information regarding a radio coverage event.

When RAN1 1252 is active in an IMS session, the transfer of session information to RAN2 1253 may provide service continuity. In order to execute a session transfer, reporting information which may be based on a radio coverage event is provided to the SCC AS 1258. The SCC AS 1258 receives the reporting information from the reporting function 1254 and initiates transfer from RAN1 1252 to RAN2 1253.

Prior to session initiation or access transfer of a session, the SCC AS 1258 may be notified of an event such as the imminent loss of a current access network by RAN1 1252. The SCC AS 1258 may send a request to register the event 1262 to the reporting function 1254. Explicit event registration is optional. Registration may occur based on configuration procedures.

WTRU 1251 via RAN1 1252 communicates using SIP signaling with the Remote Party 1260 via the SCC AS 1258. The SIP messages may be IMS control plane messages. WTRU 1251 via RAN1 1252, the SCC AS 1258 and the Remote Party 1260 may establish one or more media flows (e.g., #n+1 . . . M) 1264. In addition, WTRU 1251 via RAN2 1253, the SCC AS 1258 and the Remote Party 1260 may establish one or more media flows (e.g., #1 . . . n) 1266. The SCC AS 1258is the anchor for the session and maintains, for all active and inactive sessions, session state information.

The SCC AS 1258 may receive an indication 1268 from the reporting function that an event is about to occur. For example, the SCC AS 1258 may receive information 1268 regarding the imminent loss of a current access network by RAN1 1252. The SCC AS 1258 determines 1270 that RAN2 1253 is a potential target and is available for transfer of session information. The SCC AS 1258 determines 1270 which media flows may be authorized for transfer to RAN2 1253. This determination 1270 may be based on one or more preconfigured parameters, profiles, policy information, reporting information or input from a user.

The SCC AS 1258 sends an initiate media flow transfer (#n+1 . . . M) request 1272 to RAN2 1253 via CSCF 1256. All media flows determined as non-transferrable to RAN2 1253, which may be based on RAN2 1253 policy information, may not be transferred to RAN2 1253. RAN2 1253 sends an update media flow request (e.g., re-invite) 1274 to the CSCF 1256. The CSCF 1256 sends the update media flow request 1274 to the Remote Party 1260. The Remote Party 1260 updates the media flow 1276 and sends an update media flow ACK 1278 to RAN2 1253 via the CSCF 1256. RAN2 1253 transmits an initiate media flow transfer response (e.g., notify) 1280 to the SCC AS 1258 via CSCF 1256. The SCC AS 1258 sends an access transfer release media flow request (#n+1 . . . M) 1282, to RAN1 1252 via CSCF 1256. RAN1 1252 releases media flow 1284 and exchanges release media flow and SIP BYE requests 1286 with CSCF 1256. RAN1 1252 sends an access transfer release media flow response to the CSCF 1290. The CSCF 1256 exchanges a SIP BYE 1288 with the Remote Party 1260.

A media flow (#1 . . . M) 1292 may be established between RAN2 1253 and the Remote Party 1260.

At any point in the method of FIGS. 12B1 and 12B2, additional actions may be performed between WTRU 1251, RAN1 1252, RAN2 1253, Reporting Function 1254, CSCF 1256, SCC AS 1258 and Remote Party 1260 according to IMS IUT processes. Upon completion of the embodiment shown in FIGS. 12B1 and 12B2, RAN1 1252 and RAN2 1253 may participate in a collaborative session or the session may have been transferred to RAN2 1253.

In an alternate embodiment of FIGS. 12B1 and 12B2, the SCC AS 1258 initiates access transfer of session information based on a radio coverage event. In this embodiment, the SCC AS 1258 sends and receives additional access transfer signals. After the RAN2 1253 sends an update media flow request (e.g., re-invite) 1274 to the CSCF 1256 and prior to the CSCF 1256 sending the update media flow request 1274 to the Remote Party 1260, the CSCF 1256 sends an update media flow request 1293 to the SCC AS 1258 and the SCC AS 1258 sends a response to 1293 the CSCF 1256. Also, after the Remote Party 1260 updates the media flow 1276 and sends an update media flow ACK 1278 to RAN2 1253 via CSCF 1256, and prior to RAN2 1256 transmitting an initiate media flow transfer response 1280, the CSCF 1256 sends an update media ACK 1294 to the SCC AS 1258 and the SCC AS 1258 sends a response 1294 to the CSCF 1256.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A service centralization and continuity application server (SCC AS) for initiation of Inter-User Equipment Transfer (IUT) of an IP Multimedia (IM) Subsystem (IMS) media session, the SCC AS comprising:
a receiver configured to receive information, wherein the information includes availability information, capability information or preference information;
a processor configured to process the information to determine IUT capabilities of one or more IMS-capable wireless transmit/receive units (WTRUs) and to initiate IUT; and
a transmitter configured to transmit an IUT request to a target device.

2. The SCC AS of claim 1 wherein the information is policy and/or profile information and the policy information is received from a policy function node.

3. The SCC AS of claim 2 wherein the policy and/or the profile information includes whether a first WTRU is part of an implicit collaborative session with a second WTRU, whether the media session is transferrable between the first and the second WTRU, and whether the first or the second WTRU is preferable for a media flow transfer.

4. The SCC AS of claim 1 wherein the information is reporting information and the reporting information is received from a reporting function node

5. The SCC AS of claim 4 wherein the reporting information includes a network overload event, a network location change event, a loss of access by a network event, a WTRU location change event, a loss of access by a WTRU, an imminent loss of access by a WTRU, registration of another WTRU, a load balancing event.

6. A service centralization and continuity application server (SCC AS) for initiation of access transfer (AT) of an IP Multimedia (IM) Subsystem (IMS) media session, the SCC AS comprising:
a receiver configured to receive information, wherein the information includes availability information, capability information or preference information;
a processor configured to process the information to determine AT capabilities of one or more IMS-capable wireless transmit/receive units (WTRUs) and to initiate AT; and
a transmitter configured to transmit an AT request to a target device.

7. The SCC AS of claim 6 wherein the information is policy and/or profile information and the policy information is received from a policy function node.

8. The SCC AS of claim 7 wherein the policy and/or the profile information includes whether a first WTRU is part of an implicit collaborative session with a second WTRU, whether the media session is transferrable between the first and the second WTRU, and whether the first or the second WTRU is preferable for a media flow transfer.

9. The SCC AS of claim 6 wherein the information is reporting information and the reporting information is received from a reporting function node

10. The SCC AS of claim 9 wherein the reporting information includes a network overload event, a network location change event, a loss of access by a network event, a WTRU location change event, a loss of access by a WTRU, an imminent loss of access by a WTRU, registration of another WTRU, a load balancing event.

11. A method for Inter-User Equipment Transfer (IUT) of an IP Multimedia (IM) Subsystem (IMS) media session initiated by a service centralization and continuity application server (SCC AS), the method comprising;
receiving information, wherein the information includes availability information, capability information or preference information;
processing the information to determine IUT capabilities of one or more IMS-capable wireless transmit/receive units (WTRUs) and to initiate IUT; and
transmitting an IUT request to a target device.

12. The method of claim 11 wherein the information is policy and/or profile information and the policy information is received from a policy function node.

13. The method of claim 12 wherein the policy and/or the profile information includes whether a first WTRU is part of an implicit collaborative session with a second WTRU, whether the media session is transferrable between the first and the second WTRU, and whether the first or the second WTRU is preferable for a media flow transfer.

14. The method of claim 11 wherein the information is reporting information and the reporting information is received from a reporting function node

15. The method of claim 14 wherein the reporting information includes a network overload event, a network location change event, a loss of access by a network event, a WTRU location change event, a loss of access by a WTRU, an imminent loss of access by a WTRU, registration of another WTRU, a load balancing event.

16. A method for access transfer (AT) of an IP Multimedia (IM) Subsystem (IMS) media session initiated by a service centralization and continuity application server (SCC AS), the method comprising;
receiving information, wherein the information includes availability information, capability information or preference information;
processing the information to determine AT capabilities of one or more IMS-capable wireless transmit/receive units (WTRUs) and initiate AT; and
transmitting an AT request to a target device.

17. The method of claim 16 wherein the information is policy and/or profile information and the policy information is received from a policy function node.

18. The method of claim 17 wherein the policy and/or the profile information includes whether a first WTRU is part of an implicit collaborative session with a second WTRU, whether the media session is transferrable between the first and the second WTRU, and whether the first or the second WTRU is preferable for a media flow transfer.

19. The method of claim 16 wherein the information is reporting information and the reporting information is received from a reporting function node

20. The method of claim 19 wherein the reporting information includes a network overload event, a network location change event, a loss of access by a network event, a WTRU location change event, a loss of access by a WTRU, an imminent loss of access by a WTRU, registration of another WTRU, a load balancing event.
